(19) United States
(12) Patent Application Publication
(10) Pub. No.: US 2015/0053356 A1
(43) Pub. Date: Feb. 26, 2015

(54) Floating salt farm

(71) Applicant: JAE HYUN LIM, CRESSKILL, NJ (US)

(72) Inventor: JAE HYUN LIM, CRESSKILL, NJ (US)

(73) Assignee: PIOLI SYSTEMS INC., PALISADES PARK, NJ (US)

(21) Appl. No.: 14/515,729

(22) Filed: Oct. 16, 2014

(51) Int. Cl. B01D 1/00

(52) U.S. Cl. CPC B01D 1/0005; B01D 1/0035
USPC 159/34

(57) ABSTRACT

The present invention, the floating salt farm, is a system situated at offshore locations for producing crystallized salt and bittern through the evaporation of seawater. The energy storage tank, which is a floating salt farm component, is a storing component for accumulating electricity generated from various energy sources. A plurality of photovoltaic panels is fixed on the buoyant foundation situated at offshore locations or a barge, which is a movable structure.

### CROSS-REFERENCE TO RELATED APPLICATIONS

The application is a Continuation-in-part of U.S. patent application Ser. No. 13/662,534 filed on Oct. 28, 2012 and is claiming the benefits of U.S. Provisional Application No. 62/059,934 filed on Oct. 5, 2014. The entire disclosures of all these applications are incorporated herein by reference.

### BACKGROUND OF THE INVENTION

To produce natural sun-dried salt in traditional salt ponds, clean seawater at standard salinity, plentiful sunlight, suitable wind, and mud are needed. The produced natural sun-dried salt can be high in mineral contents due to the mud used in traditional salt ponds. The process of producing natural sun-dried salt has several limitations. One limitation is that the production of natural sun-dried salt cannot occur after sunset and before sunrise or during inclement weather conditions, such as cloudy and rainy weather, at the traditional salt pond locations due to lack of sunlight. Another limitation is, a large surface area for the evaporator basins is needed in order to intake plentiful sunlight throughout the evaporator basins. Traditional salt ponds are usually located at locations where clean seawater at standard salinity is readily available. By using the present invention, the floating salt farm, the limitations for salt production in traditional salt ponds can be overcome.

The purpose of the present invention, the floating salt farm, an offshore system, is to produce crystallized salt and bittern at offshore locations by using extracted seawater at standard salinity through evaporation. Some conditions need to be taken into account for selecting a location for the floating salt farm. It is not viable to extract seawater in the vicinity of industrial areas or large cities where the seawater can be polluted. The extracted seawater used for the present invention, the floating salt farm, can also not be in the vicinity of freshwater sources, such as rivers or icebergs, as it could lower seawater salinity. Locations with records of frequent rainfall or snow can also lower seawater salinity. If these locational conditions are fulfilled, the present invention, the floating salt farm, would work in any weather condition and at any location.

The present invention is a system which can be operated continuously at any time and at any location, in the condition that energy sources, such as fossil and renewable energy sources, are reliably and regularly supplied.

The buoyant foundation of the floating salt farm must have sufficient buoyancy and be able to support the weight of the floating salt farm components, in which the purpose of the floating salt farm components is to produce crystallized salt and bittern. The buoyancy and stability of the floating salt farm must be sufficient to withstand inclement weather conditions and hitting sea waves.

The present invention, the floating salt farm, can produce various and specific types of crystallized salt and bittern with selected properties, such as salinity level and taste, by adjusting the heating time and the heating temperature for the evaporation of seawater accordingly. Also, if selected contents are placed with the seawater during the evaporation, the produced crystallized salt and bittern can be affected to have selected properties, such as color, taste, smell, and mineral composition.

The floating salt farm can be powered by using renewable energy sources, such as photovoltaic panels fixed on the buoyant foundation of the floating salt farm and offshore wind turbines.

### BRIEF SUMMARY OF THE INVENTION

The present invention, the floating salt farm, is a system for producing crystallized salt and bittern at offshore locations.

The floating salt farm components which are fixed on a buoyant foundation, can consist of a seawater tank, an evaporator tank, and a heating tank. The seawater tank can extract seawater at standard salinity and is inserted into a filter system which removes solid substances such as sand.

The filtered seawater is then pumped into the evaporator tank, in which the evaporation of seawater is then performed to produce crystallized salt and bittern. The heating energy used for evaporating the seawater inside the evaporator tank can be supplied through a heat exchanger or heat exchangers attached to the outer or inner surface of the evaporator tank. The liquid used in the heat exchangers can be heated in the heating tank. The heating energy used for heating the heat exchangers can be supplied by energy sources, such as fossil energy sources, like oil and gas, and renewable energy sources, like wind and solar energy, which can be converted to electricity. These energy sources can be used in combination in order for the floating salt farm to be able to be operated regularly. The transport vessel can transport energy sources to the floating salt farm in order for the floating salt farm to operate at any time. The floating salt farm components can further consist of an energy storage tank which is a storing component for accumulating electricity generated from various energy sources, in which the accumulated electricity is used for operating the floating salt farm.

The floating salt farm components can also consist of a deposit tank, a storage tank, and photovoltaic panels. After the crystallized salt and bittern have been produced in the evaporator tank, the produced crystallized salt inside the evaporator tank can then be placed into the deposit tank, in which the flooring of the deposit tank can be at an angled slope to help detach the bittern that is attached to the produced crystallized salt. The produced crystallized salt and the detached bittern from the deposit tank, and the produced bittern from the evaporator tank can then be placed into the storage tank and the bittern storage tank, respectively. The storage tank also has a flooring at an angled slope to further help detach the bittern that is attached to the crystallized salt. Afterwards, the stored crystallized salt and stored bittern inside the storage tank and the bittern storage tank, respectively, can then be transported to a warehouse on the harbor through a transport vessel. The photovoltaic panels can be installed on the buoyant foundation to generate electricity for operating the floating salt farm.

In the present application, claims 1 to 5 of U.S. patent application Ser. No. 13/662,534, filed on Oct. 28, 2012, entitled “Floating Salt Farm”, are included.

### BRIEF DESCRIPTION OF DRAWINGS

FIGS. 1A and 1B are top views of different configurations of the buoyant foundation.

FIGS. 2A, 2B, and 2C are side views of different combinations of linked buoyant support structures.

FIGS. 3A and 3B are a top view and a side view of the buoyant foundation.

FIGS. 4A, 4B, and 4C illustrate different embodiments to reinforce the floating salt farm with offshore structures or support structures installed onshore.

FIG. 4D is a side view of the floating salt farm in movement by a towboat.

FIG. 4E is a top view of an embodiment of a buoyant foundation.

FIG. 4F is a side view of an embodiment of detachable connections between the offshore structure and the buoyant foundation.

FIG. 4G is a top view of an embodiment of the floating salt farm components separately installed at an offshore location and an onshore location.

FIG. 4H is a top view of an embodiment of the buoyant foundation.

FIG. 4I is a top view of an embodiment of the buoyant foundations.

FIG. 5 is a side view of a foundation wall installed.

FIG. 6A is a top view of an installed buoyant sea wall and FIGS. 6B and 6C are a front view and a side view of a buoyant sea wall.

FIG. 7 is a side view of a customized ceiling installed.

FIG. 8 is a top view of an arrangement of the floating salt farm components of an embodiment of the floating salt farm.

FIGS. 9A and 9B are a side view of the seawater tank and a perspective view of the filter system.

FIG. 10 is a side view of the seawater extraction tube.

FIGS. 11A and 11B are side views of the evaporator tank.

FIGS. 12A, 12D, and 12B are side views and a top view of the evaporator tank and FIG. 12C is a top view of the evaporator plate inside the evaporator tank.

FIG. 12E is a top view of the evaporator tank cover.

FIG. 12F is a side view of the evaporator tank.

FIGS. 13A and 13B are side views of the heat exchangers attached to the outer surface of the evaporator tank.

FIG. 13C is a side view of the embodiment of the heat exchangers attached to the outer surface and coiled around the inner surface of the evaporator tank.

FIG. 14 is a side view of a heating pipe as a heat exchanger of the evaporator tank.

FIGS. 15A and 15B are side views of the heating tank.

FIG. 16A is a side view of electric cables supplying electricity from poles on land to the floating salt farm.

FIG. 16B is a side view of electric cables supplying electricity to the floating salt farm from offshore wind turbines.

FIG. 16C is a top view of offshore wind turbines supplying electricity to the floating salt farm.

FIG. 17A is a side view of the produced crystallized salt and bittern in the evaporator tank.

FIG. 17B is a side view of the deposit tank.

FIG. 17C is a side view of the produced bittern in the evaporator tank.

FIG. 17D is a side view of the evaporator tank.

FIGS. 18A, 18B, and 18C are side views of the evaporator bin inside the evaporator tank.

FIGS. 18D and 18E are side views of embodiments of volcanic rocks inside the evaporator tank.

FIG. 19 is a side view of an embodiment of the evaporator tank.

FIG. 20 is a side view of the storage tank.

FIGS. 21A and 21B are a top view and a side view of the seawater extraction vessel.

FIGS. 22A and 22B are side views of an underwater volcano and a volcano above sea level onshore.

FIG. 22C is a side view of a volcano above sea level onshore.

FIG. 22D is a side view of an underwater thermal spring site.

FIGS. 23A and 23B are a top view and a side view of a barge.

FIG. 24 is a top view of the facilities on the harbor.

### DETAILED DESCRIPTION OF THE INVENTION

Detailed embodiments of the invention can be illustrated using the accompanying drawings as reference.

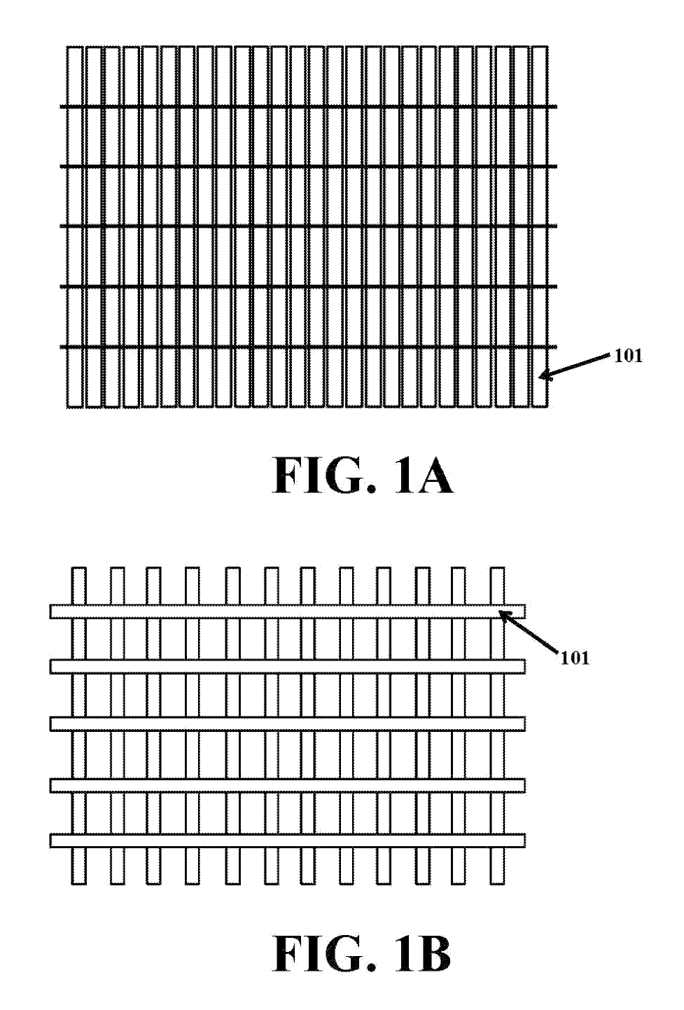

The buoyant foundation 101 of the floating salt farm must have sufficient buoyancy and must be able to support the weight of the floating salt farm components 400, which are supported by the buoyant foundation 101. The buoyant foundation 101 can be composed of linked buoyant support structures 102 and can be arranged into different configurations, as shown in FIGS. 1A and 1B.

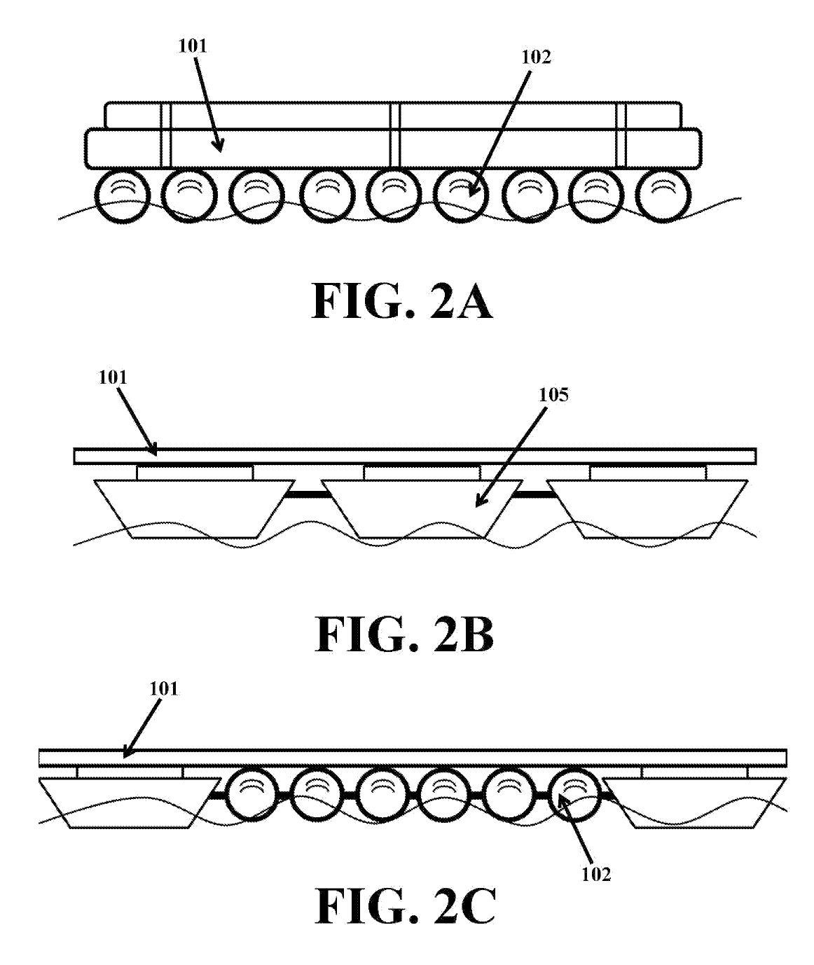

Buoyant support structures 102, which are used to support the buoyant foundation 101 of the floating salt farm, can be composed of linked buoyant support structures 102, as shown in FIG. 2A. The buoyant foundation 101 can also be installed on top of linked small flat-bottomed boats 105, as shown in FIG. 2B. A linked combination of different types of buoyant support structures 102 can be used, as shown in FIG. 2C.

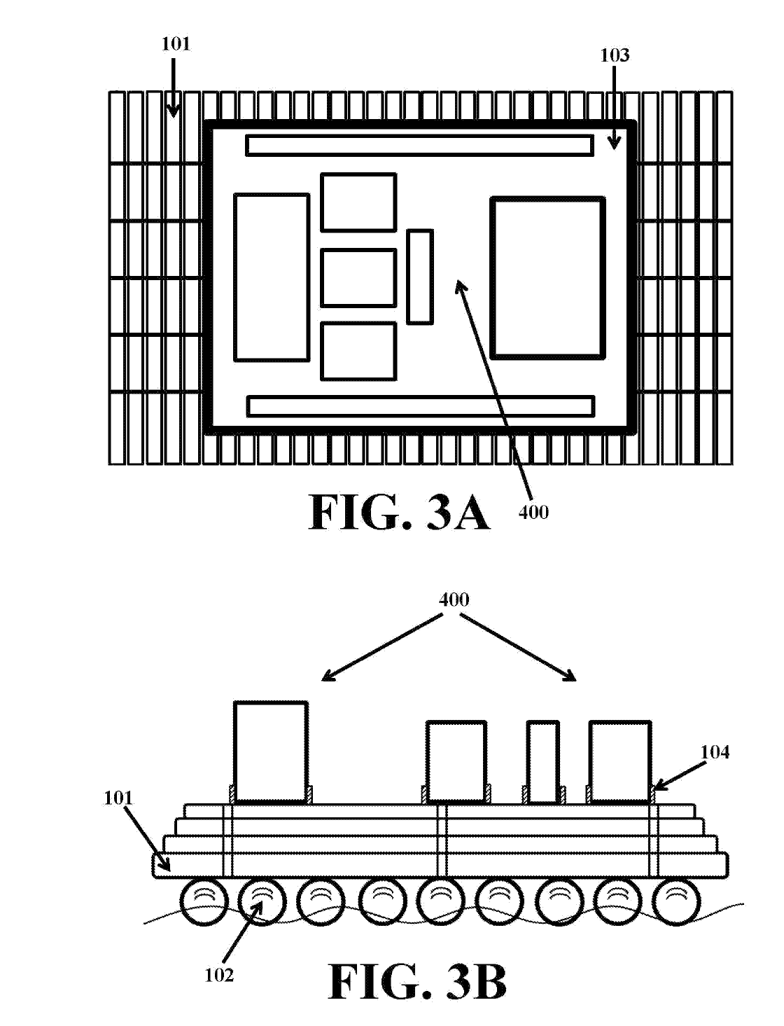

The floating salt farm components 400 are fixed on the surface of the flooring deck 103, in which the flooring deck 103 is installed on top of the buoyant foundation 101, as shown in FIGS. 3A and 3B. The floating salt farm must have sufficient buoyancy and stability to withstand inclement weather conditions and hitting sea waves. To increase stability, the buoyant foundation 101 can be wider and higher, as shown in FIGS. 3A and 3B. The floating salt farm components 400 can be reinforced with the tank supports 104.

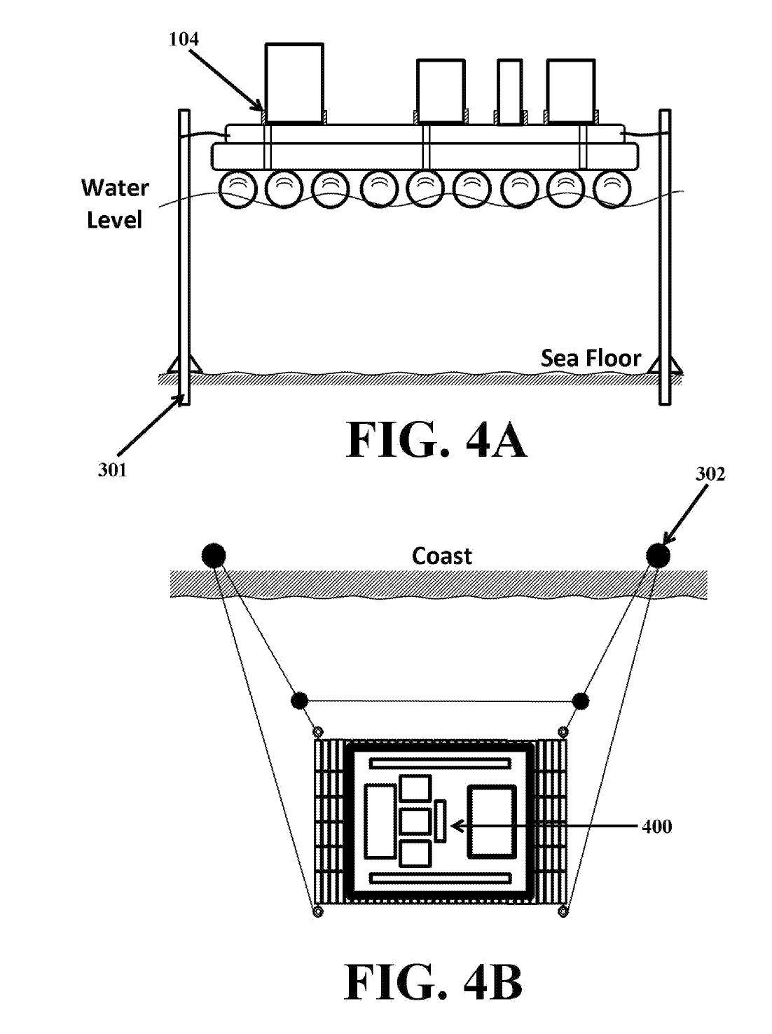

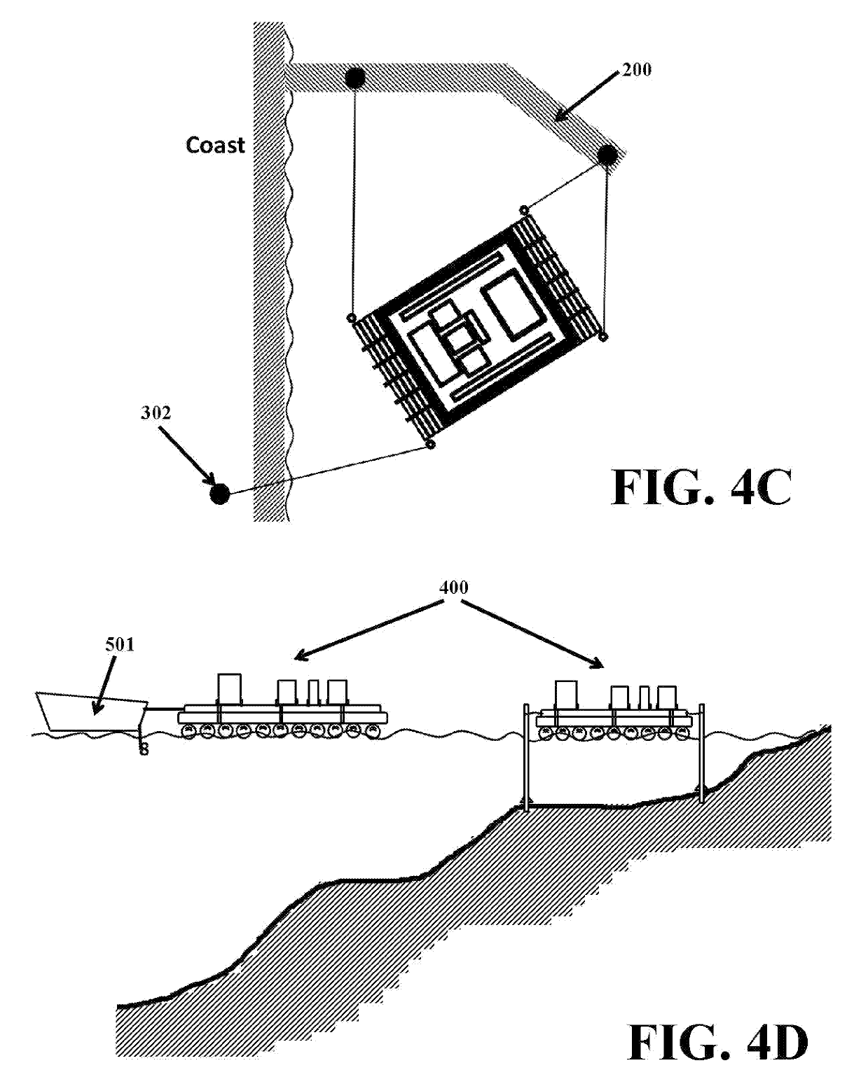

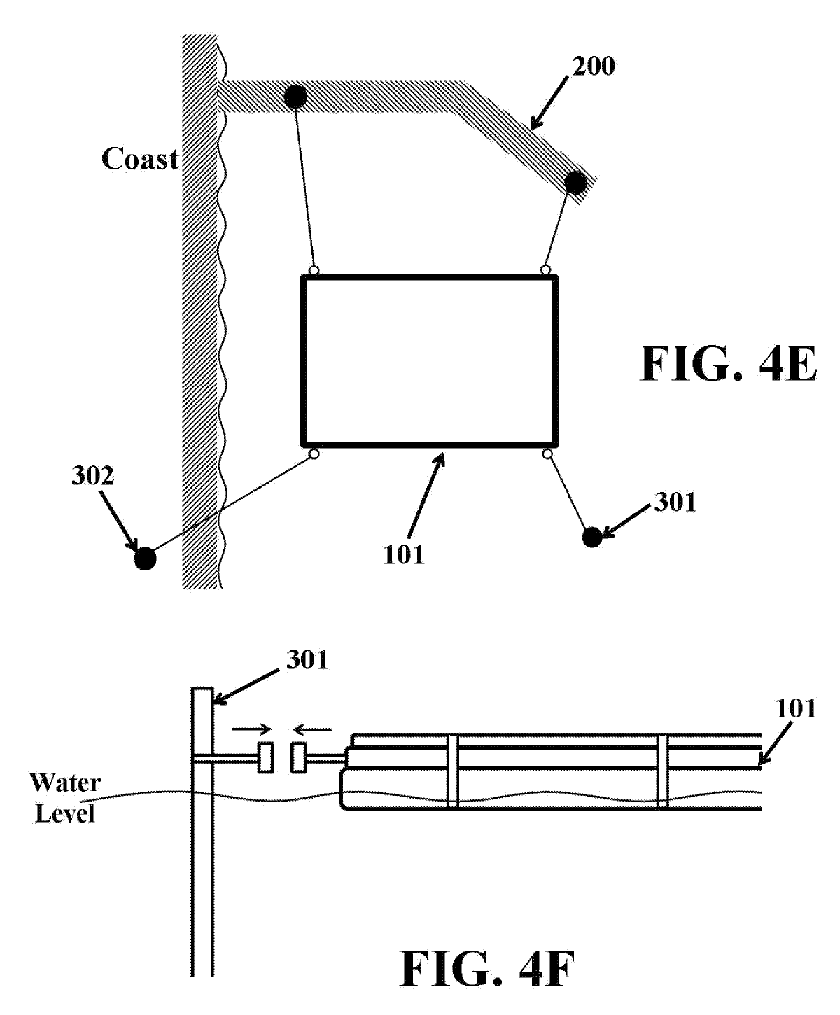

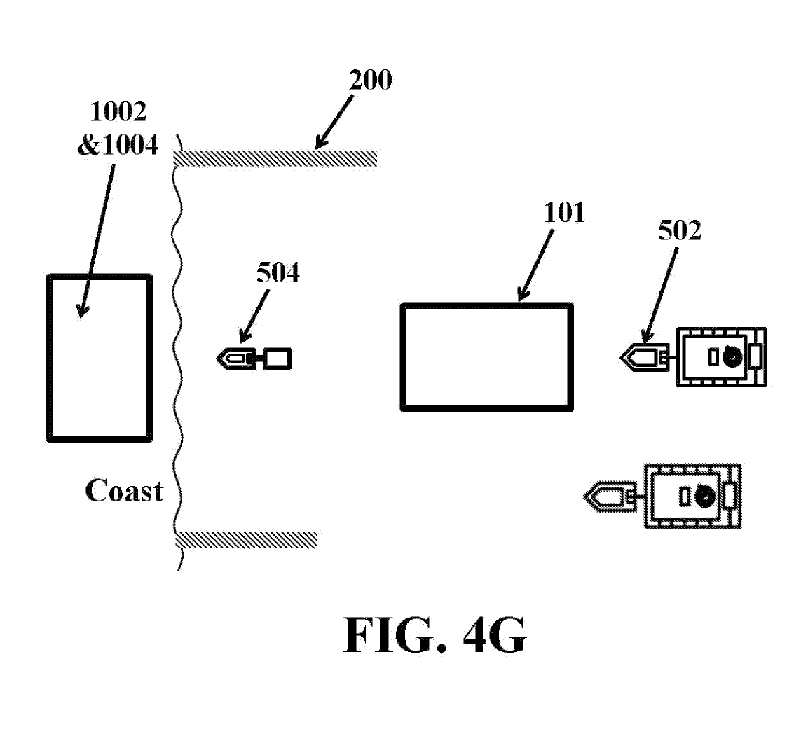

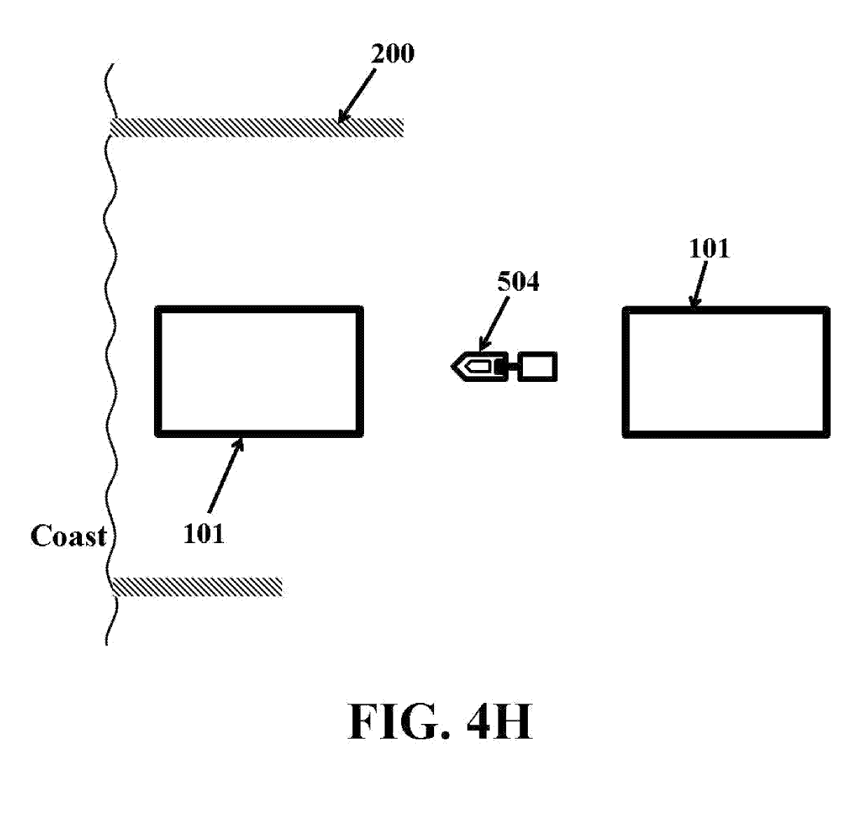

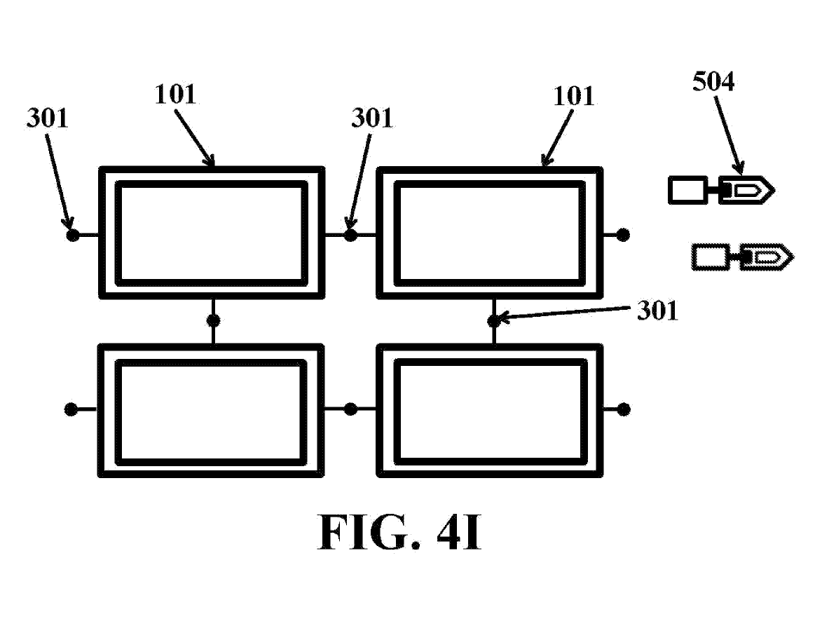

The floating salt farm can be reinforced with offshore structures 301, as shown in FIG. 4A. A floating salt farm can also be reinforced with support structures 302 installed onshore, as shown in FIG. 4B, or on the breakwater 200, as shown in FIG. 4C. At locations where the floating salt farm cannot be reinforced with offshore structures 301 or support structures 302 installed onshore, the floating salt farm can be moved by a towboat 501 when transporting the floating salt farm to an offshore location, as shown in FIG. 4D. The floating salt farm can also be reinforced with a combination of at least one offshore structure 301 and at least one support structure 302, installed onshore or on the breakwater 200, as shown in FIG. 4E. The offshore structures 301 can be detached from the buoyant foundation 101 through detachable connections, as shown in FIG. 4F.

At locations where higher stability may be needed, such as at locations with recurring inclement weather conditions, a deposit tank 1002 and a storage tank 1004, which are floating salt farm components 400, can be separately installed at a selected location, such as at a harbor with breakwaters 200, as shown in FIG. 4G. In the embodiment shown in FIG. 4G, at least one seawater extraction vessel 502 extracts seawater at an offshore location, in which at least one seawater extraction vessel 502 transports the extracted seawater, which is used for producing crystallized salt and bittern, to the floating salt farm situated at offshore locations. After the evaporation of seawater inside an evaporator tank 701, which is a floating salt farm component 400, a transport vessel 504 transports the produced crystallized salt and bittern, to a deposit tank 1002 and a storage tank 1004, which are installed at an onshore location. At the onshore location, such as at a harbor, facilities for further processing of the produced crystallized salt and bittern can also be installed.

The floating salt farm components 400 can be separated and installed in separate buoyant foundations 101, in which each buoyant foundation 101 is situated at offshore locations, as shown in FIGS. 4H and 4I.

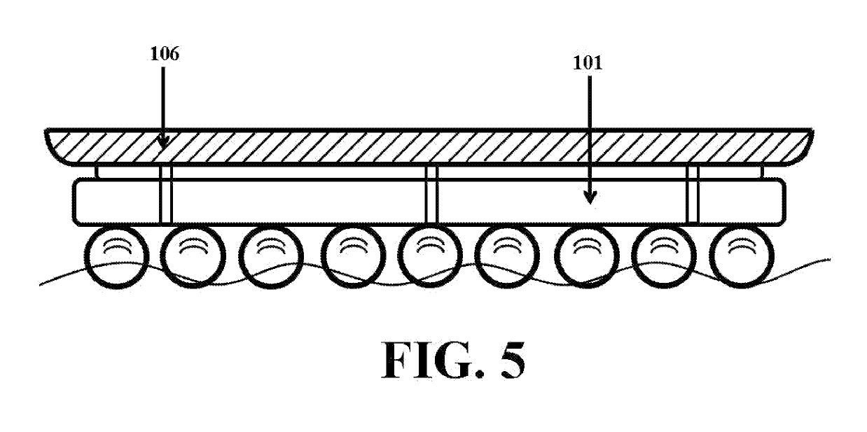

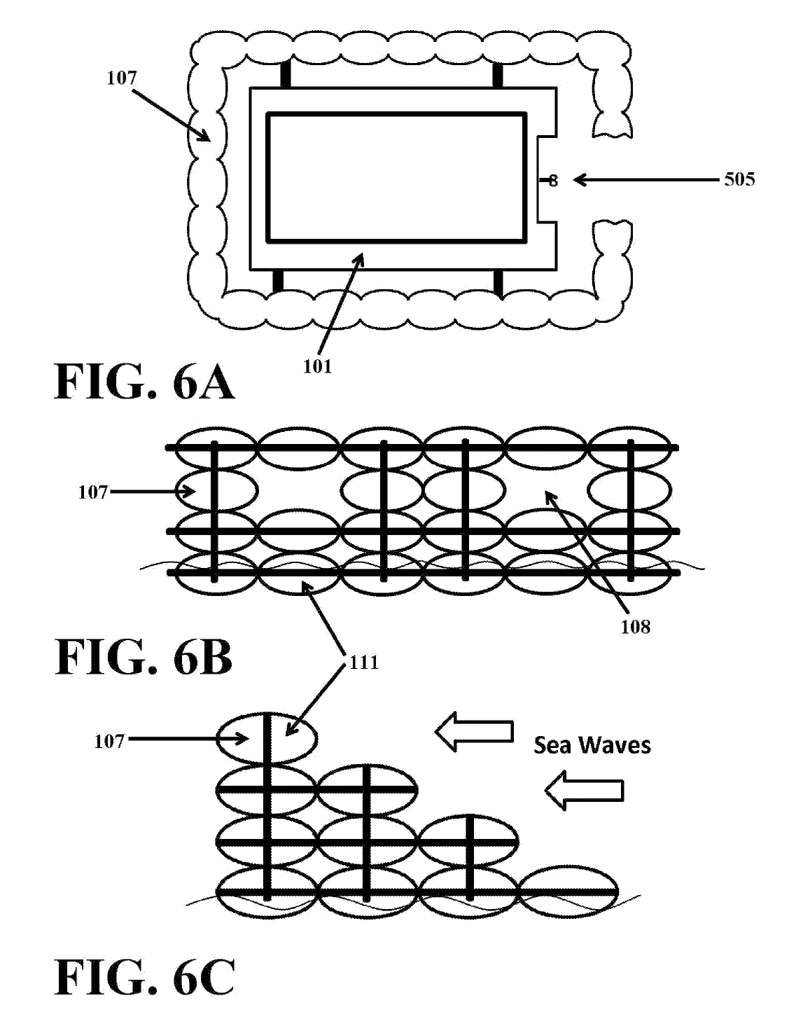

In order to further protect the floating salt farm components 400 from hitting sea waves, a foundation wall 106 can be installed on the buoyant foundation 101, as shown in FIG. 5. A buoyant sea wall 107, a floating structure, can be installed to the buoyant foundation 101 for increasing the buoyancy of the buoyant foundation 101. A buoyant sea wall 107 is installed around the perimeter of and slightly away from the buoyant foundation 101, as shown in FIG. 6A. The buoyant sea wall 107 can be detached from the buoyant foundation 101 through detachable connections, be composed of several layers of linked buoyant structures 111, and have wind openings 108 to prevent winds from damaging the buoyant sea wall 107, as shown in FIGS. 6B and 6C. The buoyant foundation 101 with an attached buoyant sea wall 107 can also have at least one motor propeller 505 installed, as shown in FIG. 6A. During inclement weather conditions, the buoyant foundation 101 can be moved to a safe location, such as the harbor, as shown in FIG. 6A.

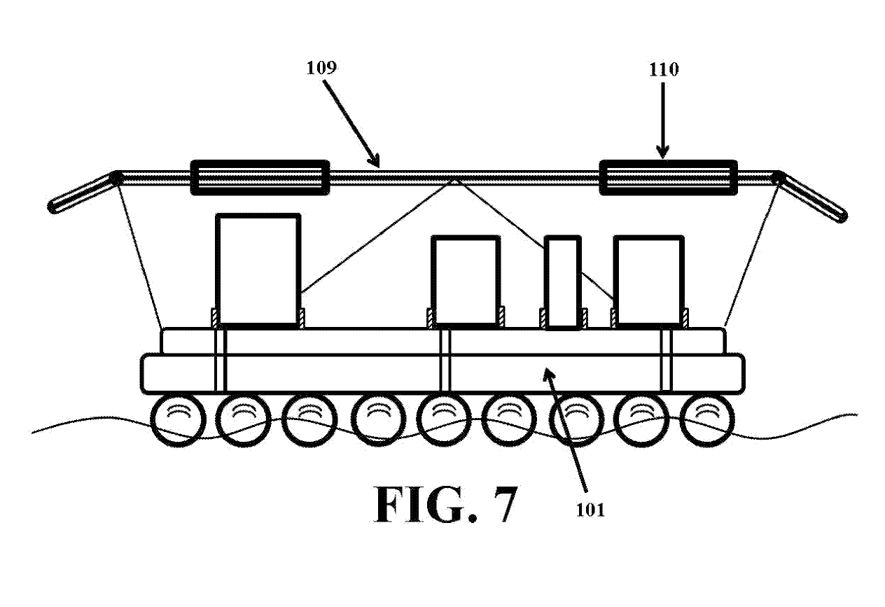

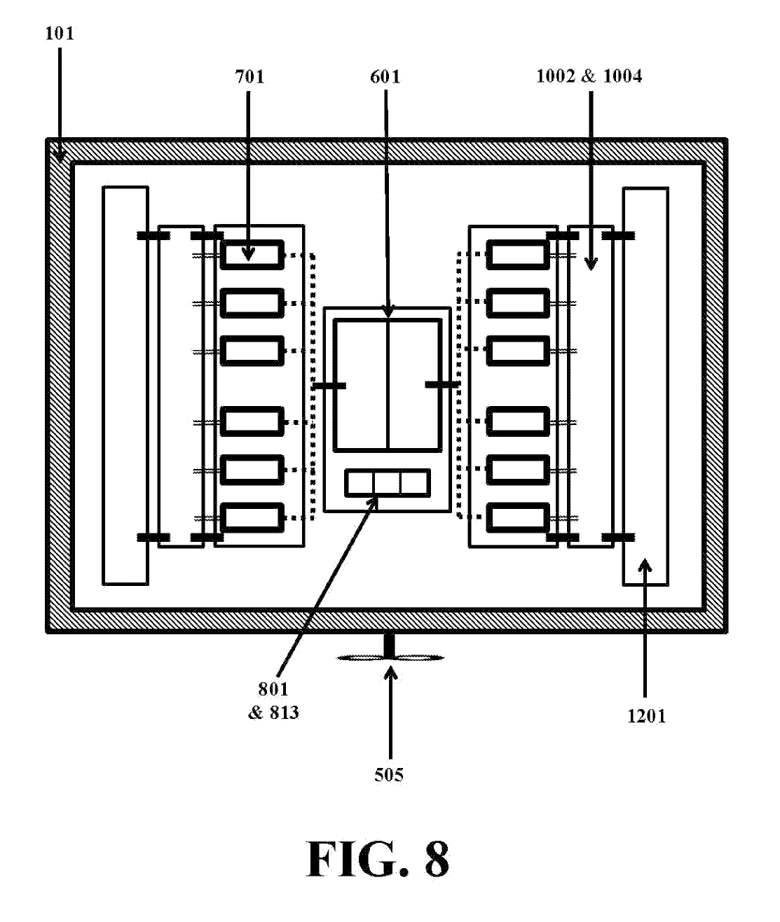

The floating salt farm components 400 can be further protected from inclement weather conditions by an installed customized ceiling 109 as shown in FIG. 7. The customized ceiling 109 can have several windows 110, which can be movable along the surface of the customized ceiling 109, in order to intake sunlight for the installed plurality of photovoltaic panels 1201, which are floating salt farm components 400, as shown in FIGS. 7 and 8.

The floating salt farm components 400, which are fixed on at least one buoyant foundation 101 with at least one installed motor propeller 505, can consist of at least one seawater tank 601, at least one evaporator tank 701, at least one heating tank 801, at least one energy storage tank 813, at least one deposit tank 1002, at least one storage tank 1004, and a plurality of photovoltaic panels 1201, as shown in FIG. 8.

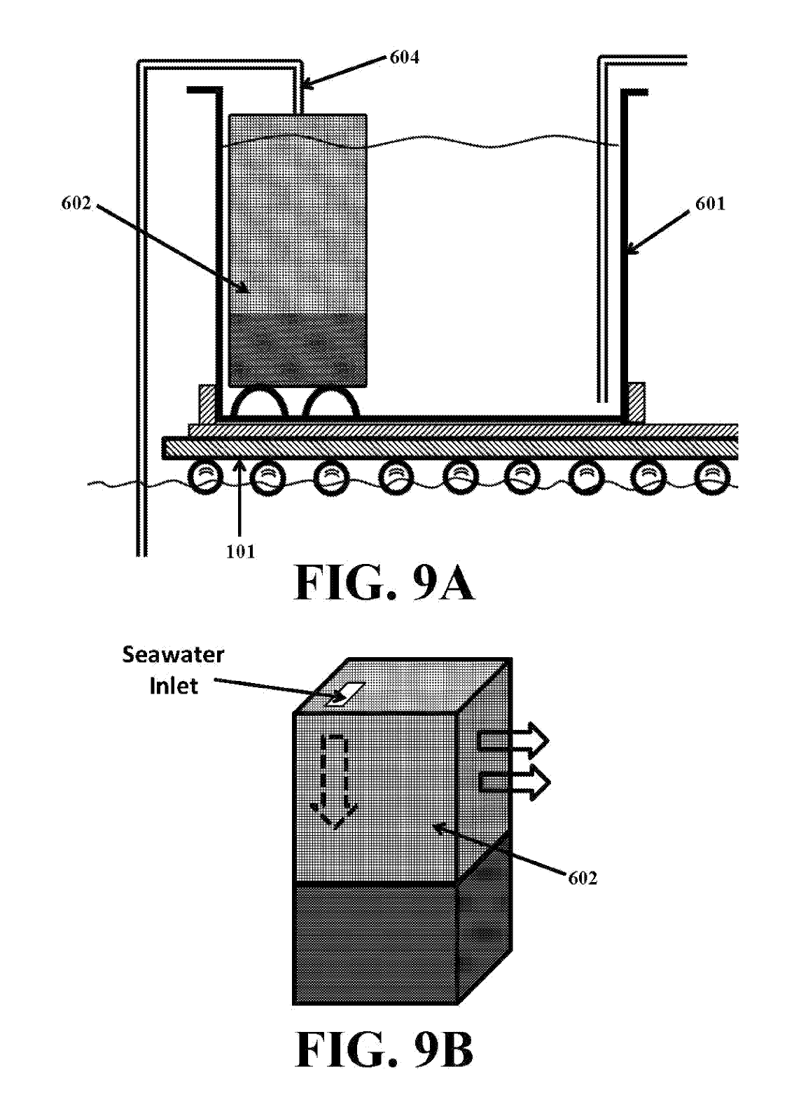

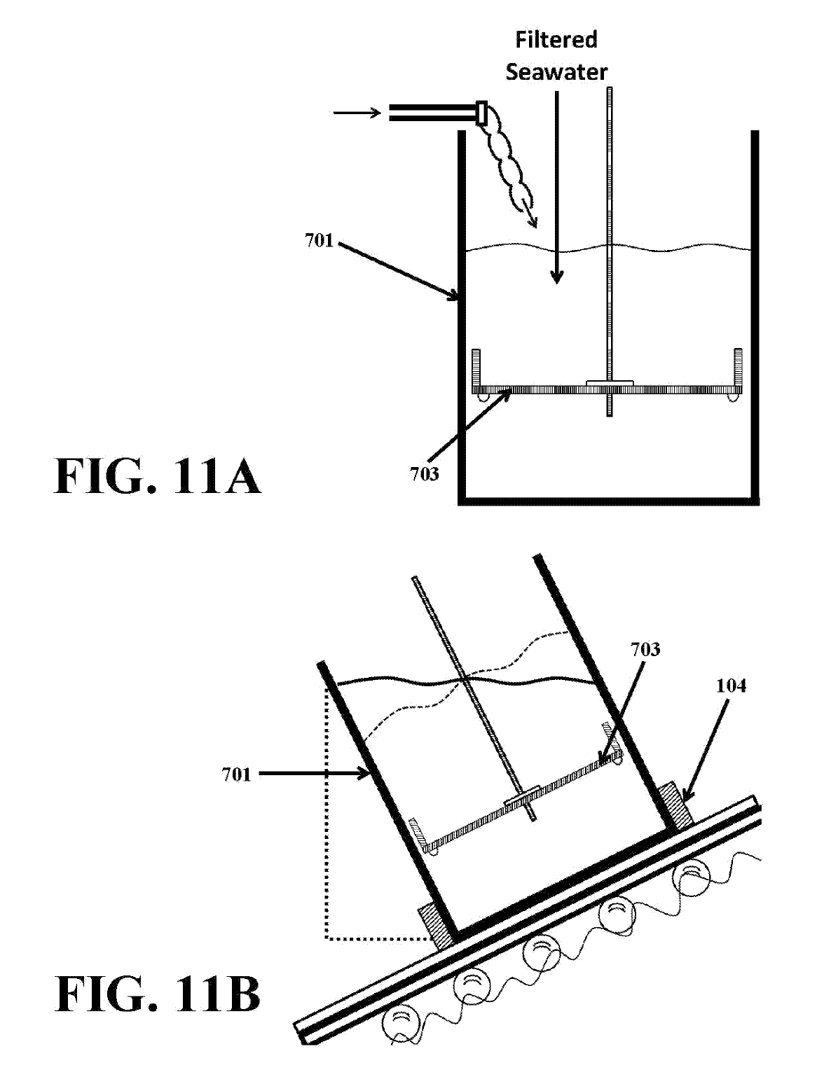

The seawater tank 601 can extract seawater at standard salinity with a seawater extraction tube 604 and is inserted into a filter system 602 inside the seawater tank 601, as shown in FIG. 9A. The filter system 602, as shown in FIG. 9B, removes solid substances such as sand, from the extracted seawater. Afterwards, the filtered seawater is pumped into the evaporator tank 701, as shown in FIG. 11A.

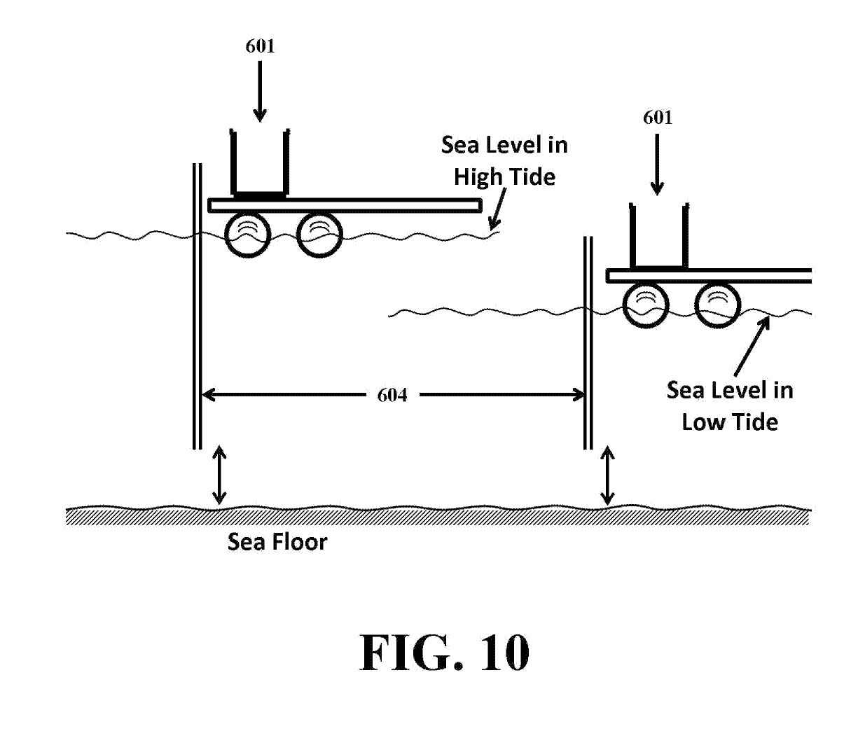

To be able to extract seawater at a selected distance from the sea floor, the seawater extraction tube 604 can be adjustable in height, regardless whether the selected offshore location is in high tide or low tide, as shown in FIG. 10.

The filtered seawater from the seawater tank 601, as shown in FIG. 9A, is pumped into the evaporator tank 701, as shown in FIG. 11A, in which the filtered seawater is evaporated to produce crystallized salt and bittern. The amount of filtered seawater inside the evaporator tank 701 can be controlled. The water level inside the evaporator tank 701 must not be too high, as shown in FIG. 11B, in order to prevent the filtered seawater to spill out of the evaporator tank 701 when evaporator tank 701 is shaken by hitting sea waves. The evaporator tank 701 can be reinforced by tank supports 104.

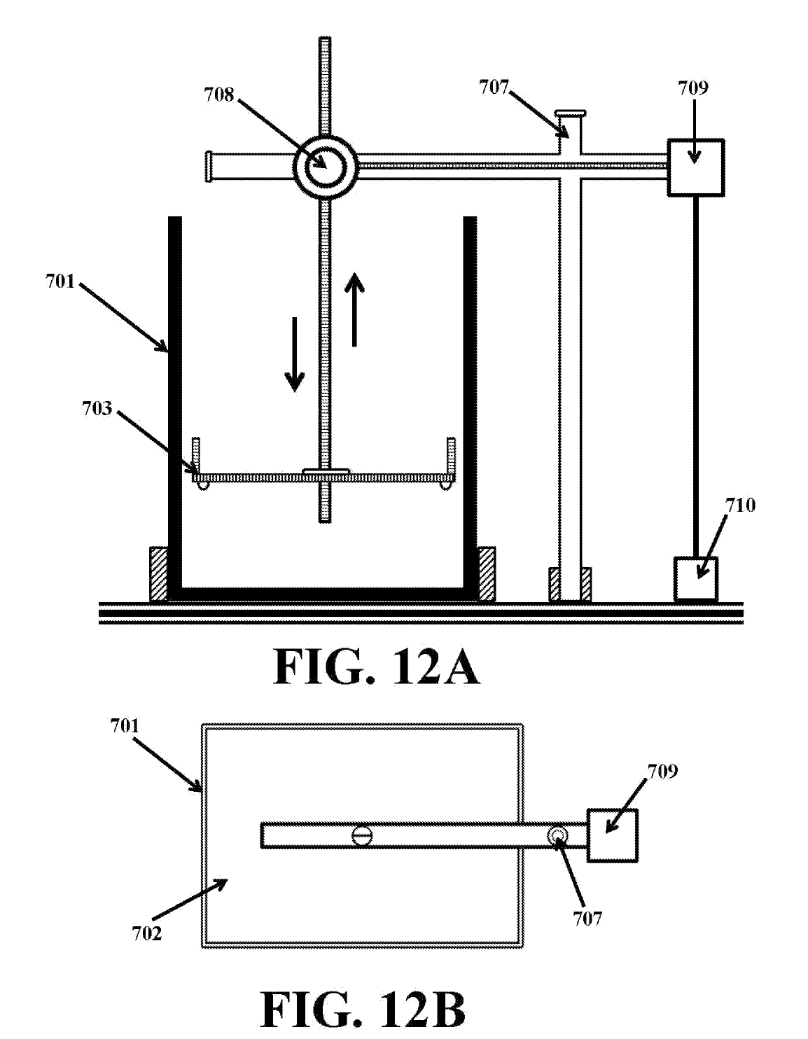

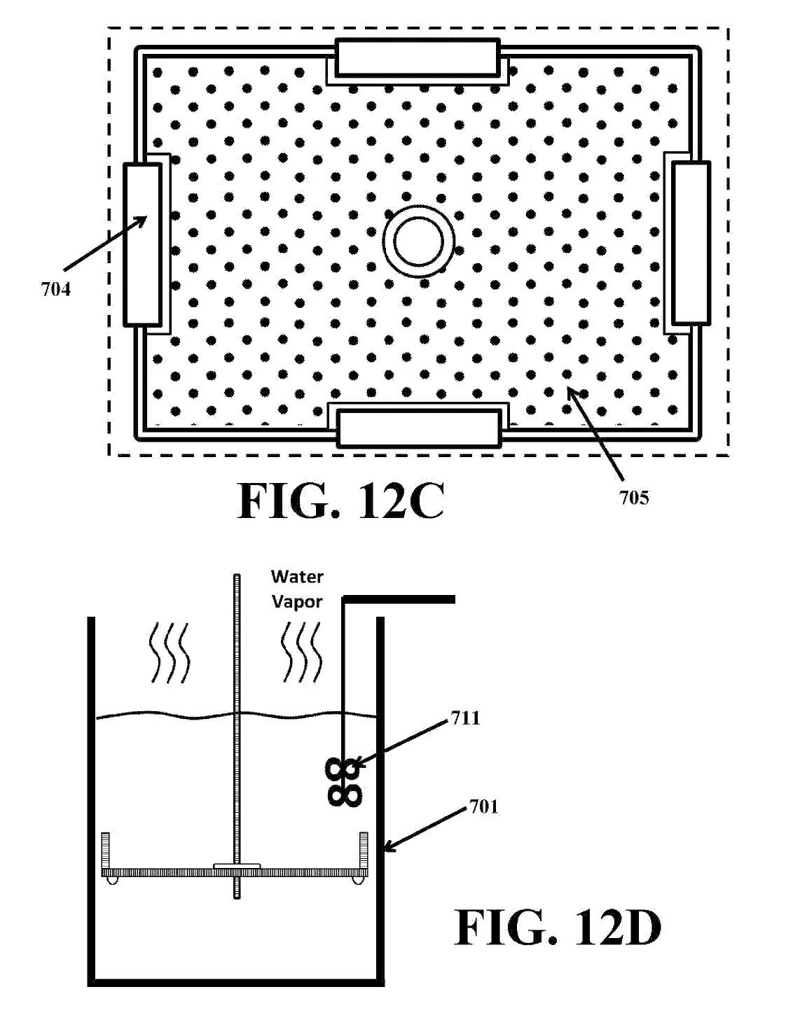

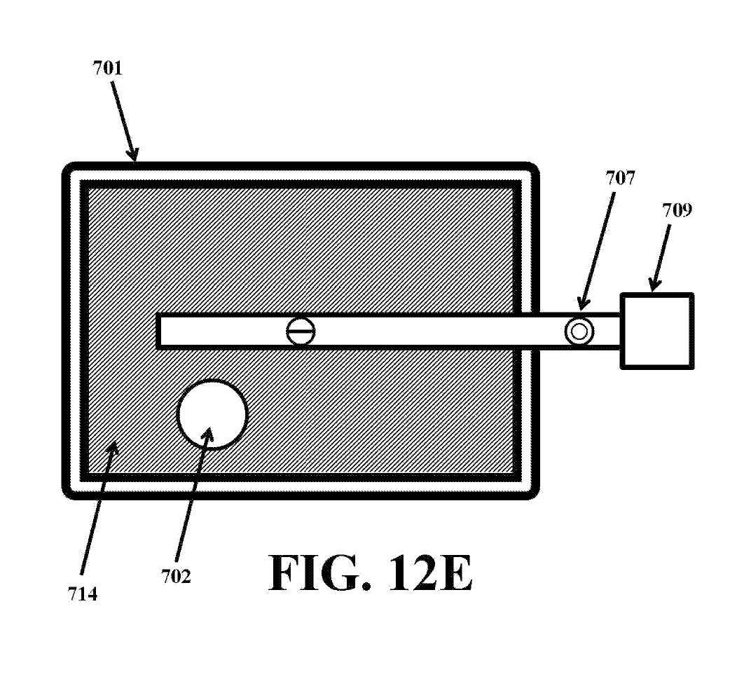

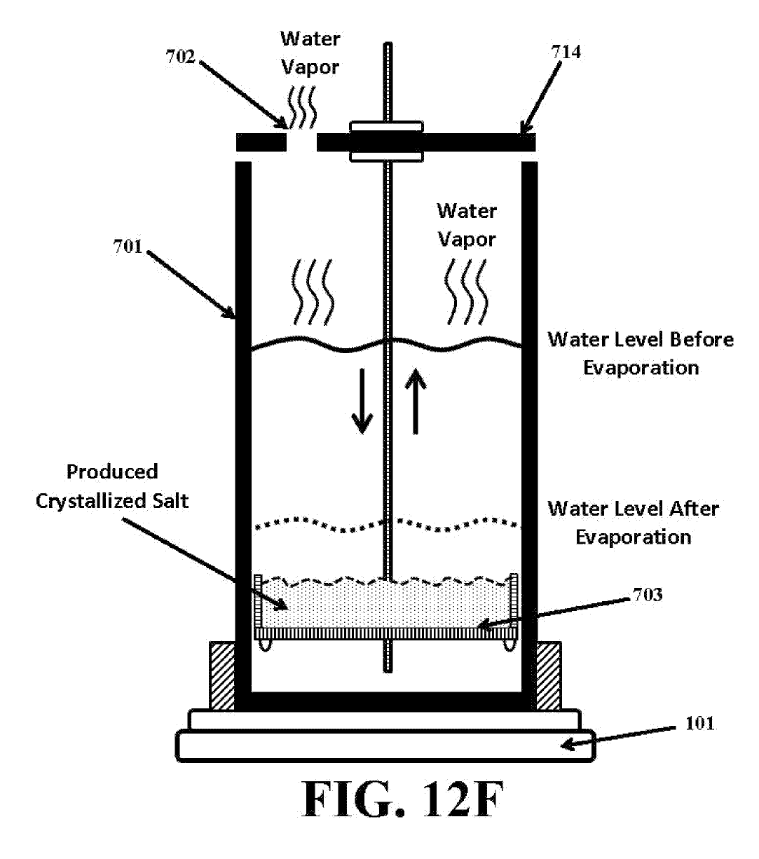

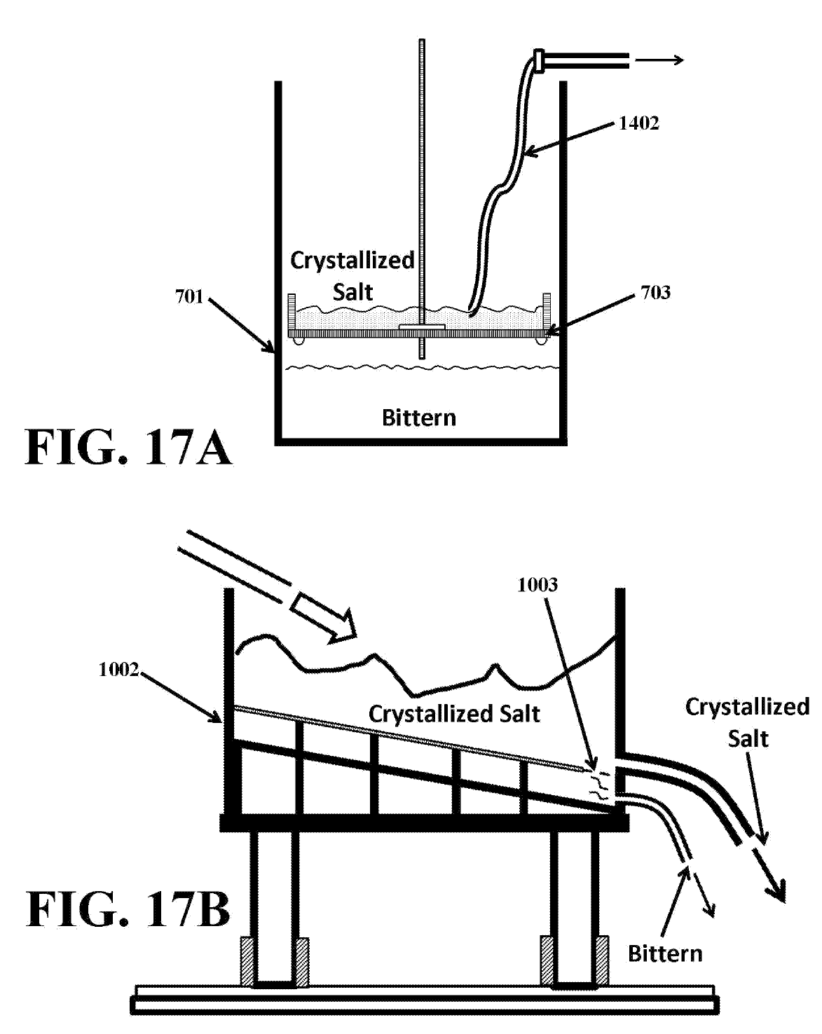

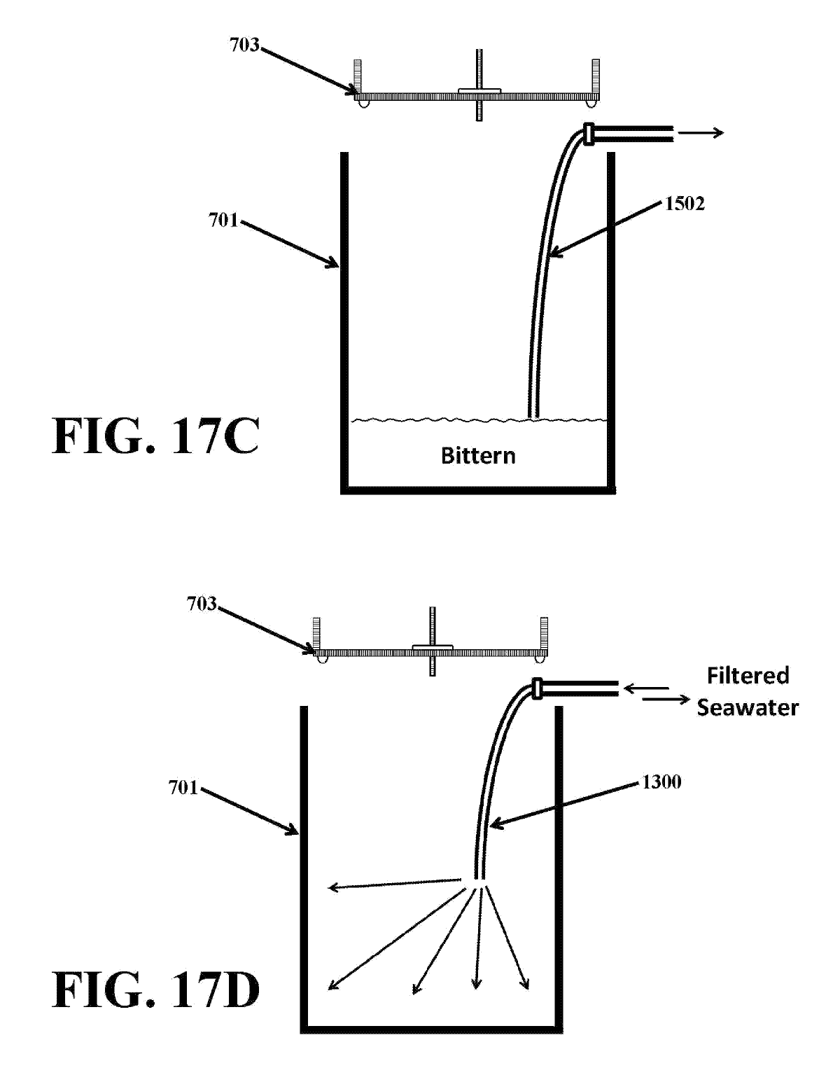

The evaporator plate 703 inside the evaporator tank 701, is adjusted in height by using a gearbox 708, an evaporator plate support 707, a motor 709, and an evaporator plate controller 710, as shown in FIG. 12A. The evaporator plate surface 705 can be parallel to the bottom of the evaporator tank 701 and has a smaller perimeter than the perimeter of the evaporator tank 701 in order for the evaporator plate 703 to be able to fit inside the evaporator tank 701. The evaporator plate surface 705 has small holes, which form a sieve surface, as shown in FIG. 12C. The sieve surface of the evaporator plate 703 captures the produced crystallized salt and allows the produced bittern mixed with the captured produced crystallized salt to seep through to the bottom of the evaporator tank 701 when the evaporator plate 703 is lifted above the water level in the evaporator tank 701 after the evaporation of seawater, as shown in FIG. 17A. The evaporator plate 703 has circulation openings 704 to allow the seawater to circulate below and above the evaporator plate 703 during the evaporation of seawater, as shown in FIG. 12C. After the evaporation of seawater, the produced crystallized salt lies on the evaporator plate 703 and the produced bittern lies below the evaporator plate 703 at the bottom of the evaporator tank 701, as shown in FIG. 17A. At least one mixer 711 inside the evaporator tank 701, can be used for circulating the seawater during the evaporation of seawater, as shown in FIG. 12D.

The evaporator tank 701 can have an open top, such as an evaporator tank opening 702, as shown in FIG. 12B, to release the produced water vapor to the atmosphere during the evaporation of seawater. The evaporator tank 701 can also have an evaporator tank cover 714, which is installed at the top of the evaporator tank 701 and can be detachable. The evaporator tank cover 714 can have an evaporator tank opening 702 for releasing the produced water vapor to the atmosphere during the evaporation of seawater, as shown in FIGS. 12E and 12F.

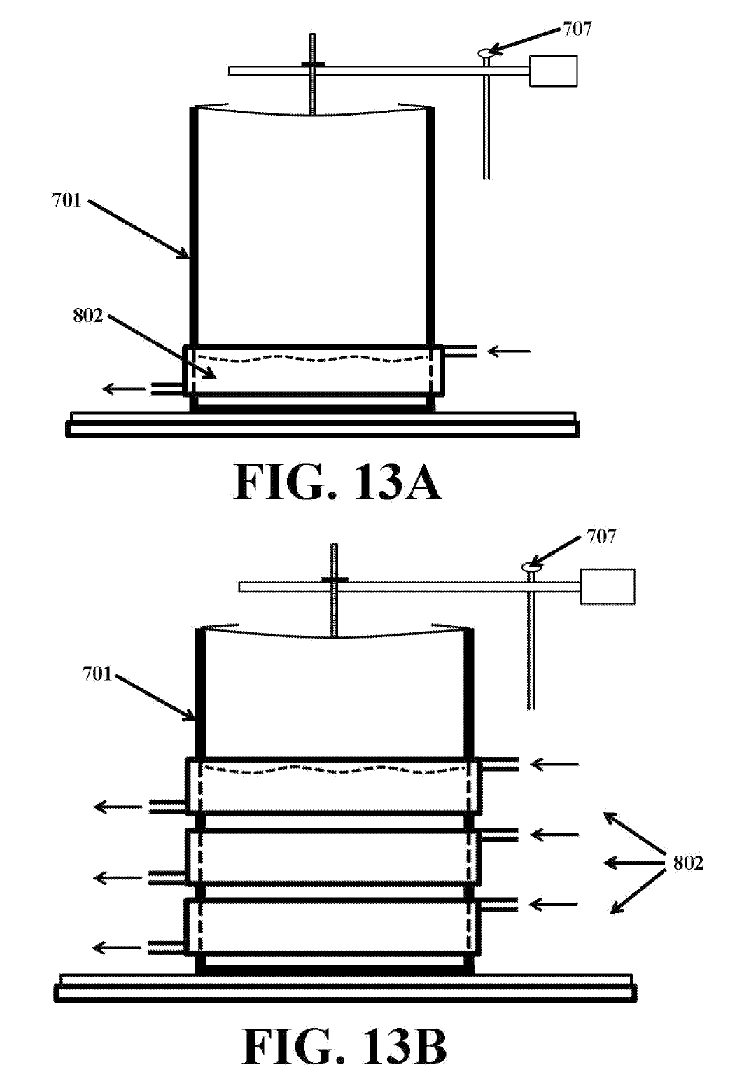

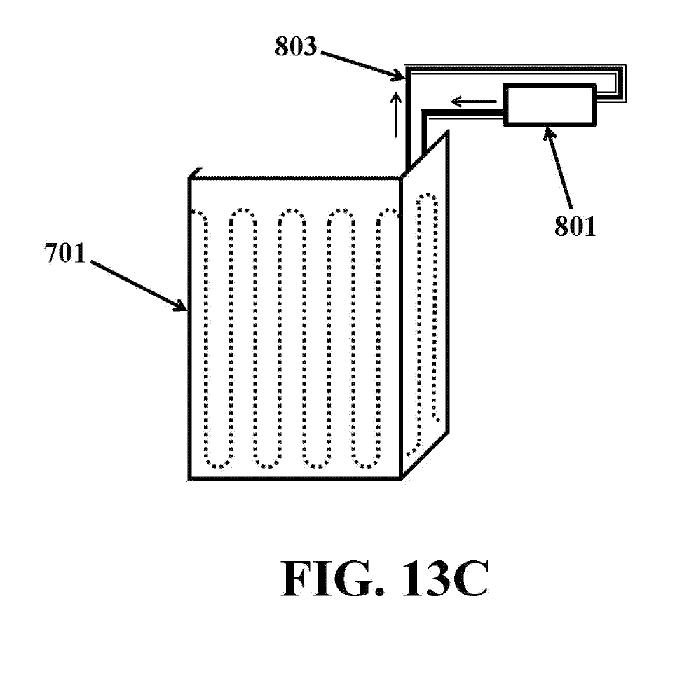

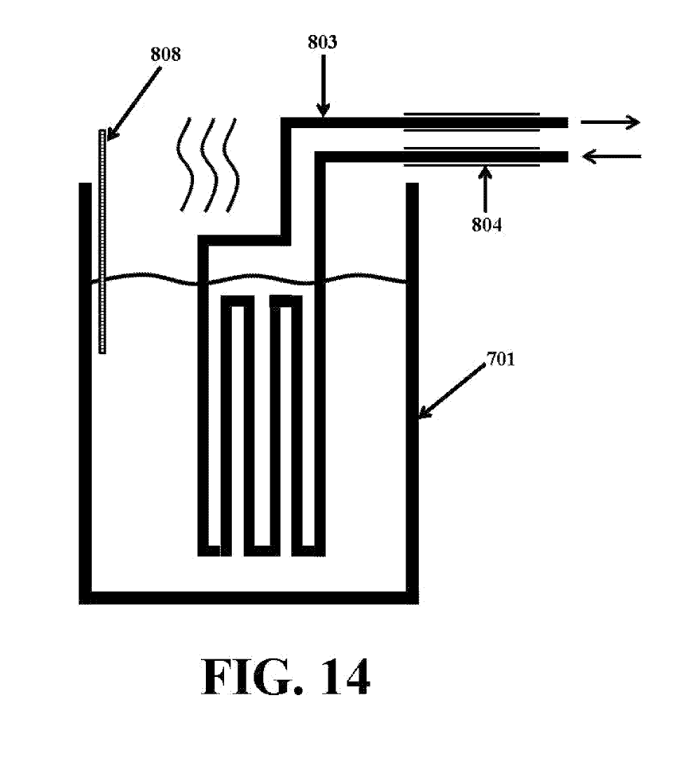

The heating used for the evaporation of seawater in the evaporator tank 701 can be supplied through at least one heat exchanger 802 attached to the outer surface of the evaporator tank 701, as shown in FIGS. 13A and 13B. Another heating method which can also be used for the evaporation of seawater is by using a heating pipe 803 coiled around the inner surface of the evaporator tank 701 as at least one heat exchanger 802, as shown in FIGS. 13C and 14. Pipe coverings 804 can also be attached around the heating pipe 803 to reduce heat loss.

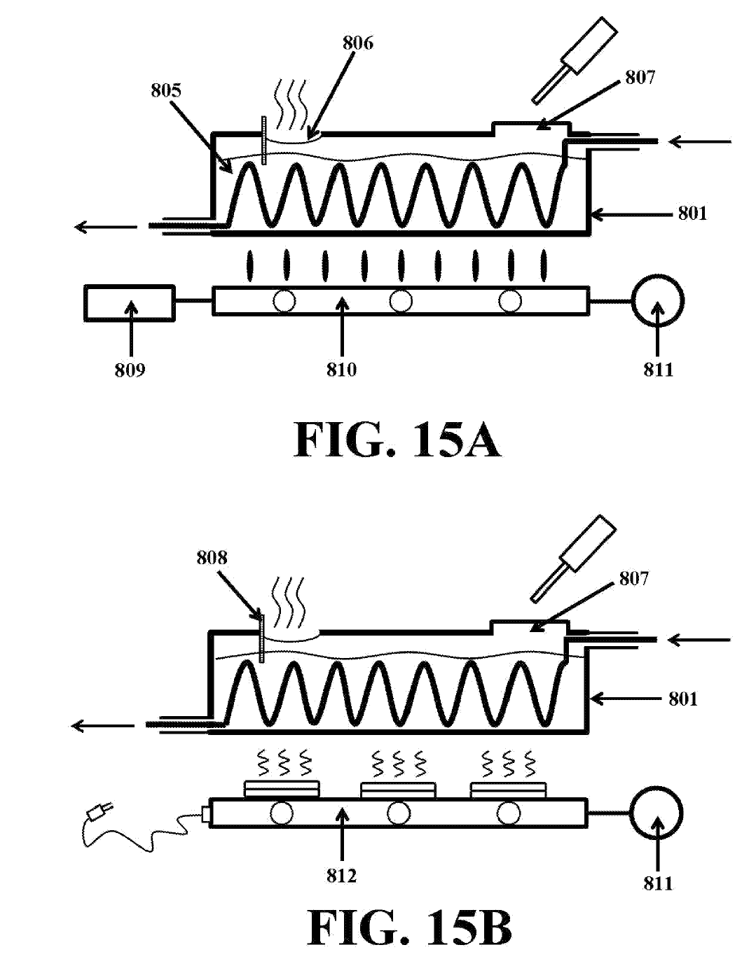

The heating tank 801 supplies heating energy to the evaporator tank 701 through heat exchangers 802. The liquid 805 used in the heat exchanger 802 is heated in the heating tank 801. The heat exchanger 802 can be heated through a gas burner 810, in which the gas burner 810 uses gas supplied from the gas tank 809, as shown in FIG. 15A. The heat exchanger 802 can also be heated through an electric heater 812, as shown in FIG. 15B. The heating tank 801 comprises the heating tank liquid 805, the liquid inlet 807, the heating tank opening 806, and the temperature gauge 808, as shown in FIGS. 15A and 15B. A heat controller 811, an element of the heating tank 801, as shown in FIGS. 15A and 15B, is a device which can adjust the heating time and the heating temperature for the evaporation of seawater in the evaporator tank 701. The present invention, the floating salt farm, can produce various and specific types of crystallized salt and bittern with selected properties, such as salinity level and taste, by adjusting the heating time and the heating temperature accordingly.

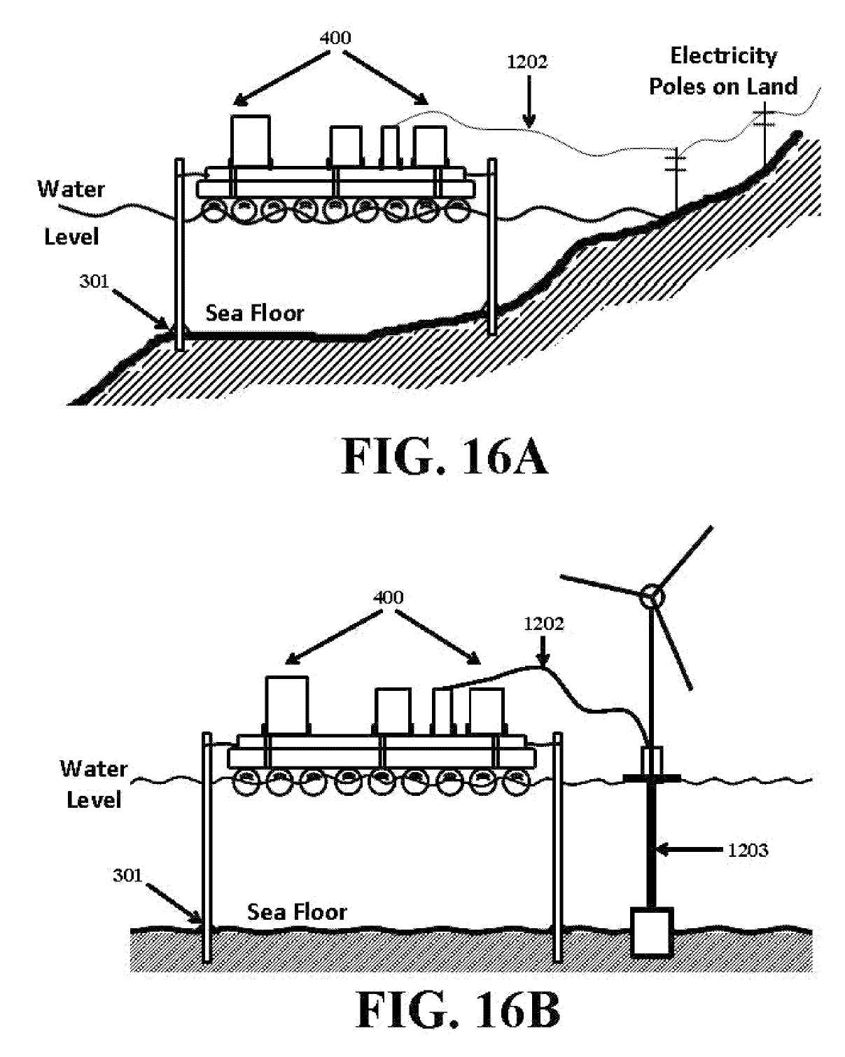

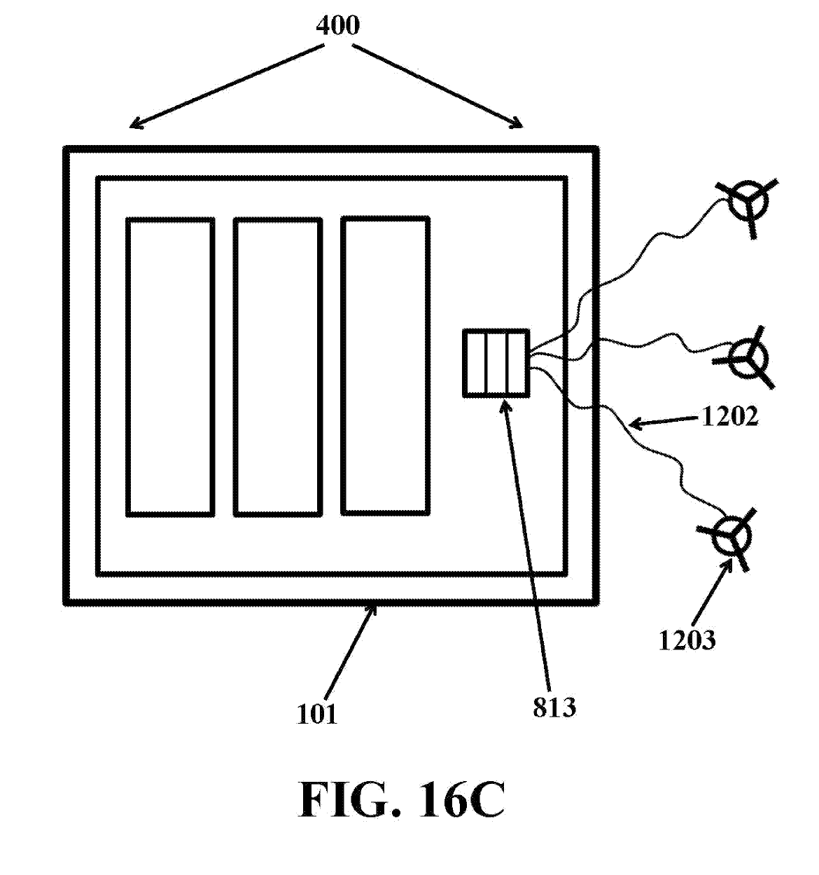

Electricity can be supplied to the floating salt farm through electric cables 1202 connected to electricity poles located onshore, as shown in FIG. 16A or through electric cables 1202 connected to offshore wind turbines 1203, as shown in FIGS. 16B and 16C, to be used for operating the floating salt farm. The floating salt farm components 400 can also consist of at least one energy storage tank 813 which is a storing component for accumulating electricity generated from (1) a plurality of photovoltaic panels 1201 which are fixed on the buoyant foundation 101, (2) at least one offshore wind turbine 1203, or (3) a combination of a plurality of photovoltaic panels 1201 and at least one offshore wind turbine 1203, such that at least one energy storage tank 813 supplies accumulated electricity for operating the floating salt farm components 400, as shown in FIG. 16C.

The present invention, the floating salt farm, is a system to produce crystallized salt and bittern. After the evaporation of seawater has been conducted in the evaporator tank 701, the produced crystallized salt and the bittern remain in the evaporator tank 701. After the evaporator plate 703 is lifted above the produced bittern, the produced crystallized salt lies on the evaporator plate 703 and the produced bittern lies at the bottom of the evaporator tank 701 below the evaporator plate 703, as shown in FIG. 17A. The produced crystallized salt can then be pumped into the deposit tank 1002 through a crystallized salt extraction tube 1402, as shown in FIGS. 17A and 17B.

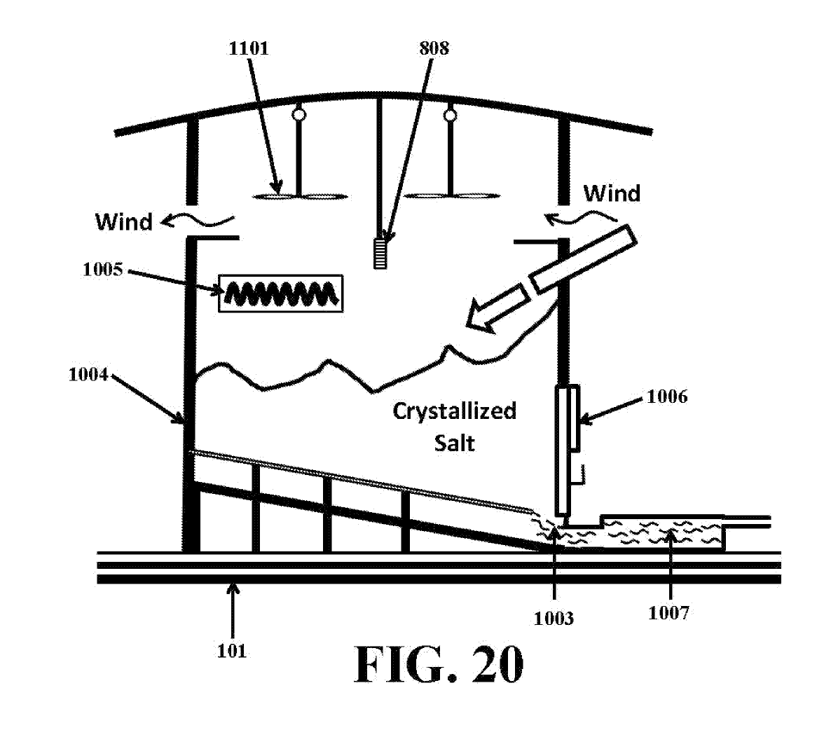

The flooring of the deposit tank 1002 can be at an angled slope to help detach the bittern that is attached to the crystallized salt. At the bottom of the angled flooring, there can be a mesh opening 1003 to allow the detached bittern to seep through to the bottom of the slope. The deposit tank 1002 can have a device to determine the time when the produced crystallized salt and detached bittern are ready to be moved to the storage tank 1004 and the bittern storage tank 1007 respectively, as shown in FIG. 20.

After the evaporation of seawater has been conducted in the evaporator tank 701, the produced crystallized salt lying on the evaporator plate 703 is extracted into the deposit tank 1002 through the crystallized salt extraction tube 1402. After extracting the crystallized salt, the evaporator plate 703 is lifted above the top of the evaporated tank 701 with an evaporator plate controller 710, as shown in FIGS. 12A and 17C, the produced bittern at the bottom of the evaporator tank 701 can then be extracted through the bittern extraction tube 1502, as shown in FIG. 17C, and pumped into the bittern storage tank 1007, as shown in FIG. 20.

After the evaporation of seawater is repeated several cycles, the evaporator tank 701 can be cleaned using a pressurized hose 1300 spraying filtered seawater, as shown in FIG. 17D, in which afterwards, the seawater used for cleaning is extracted through an extraction tube. The evaporation of seawater is then resumed.

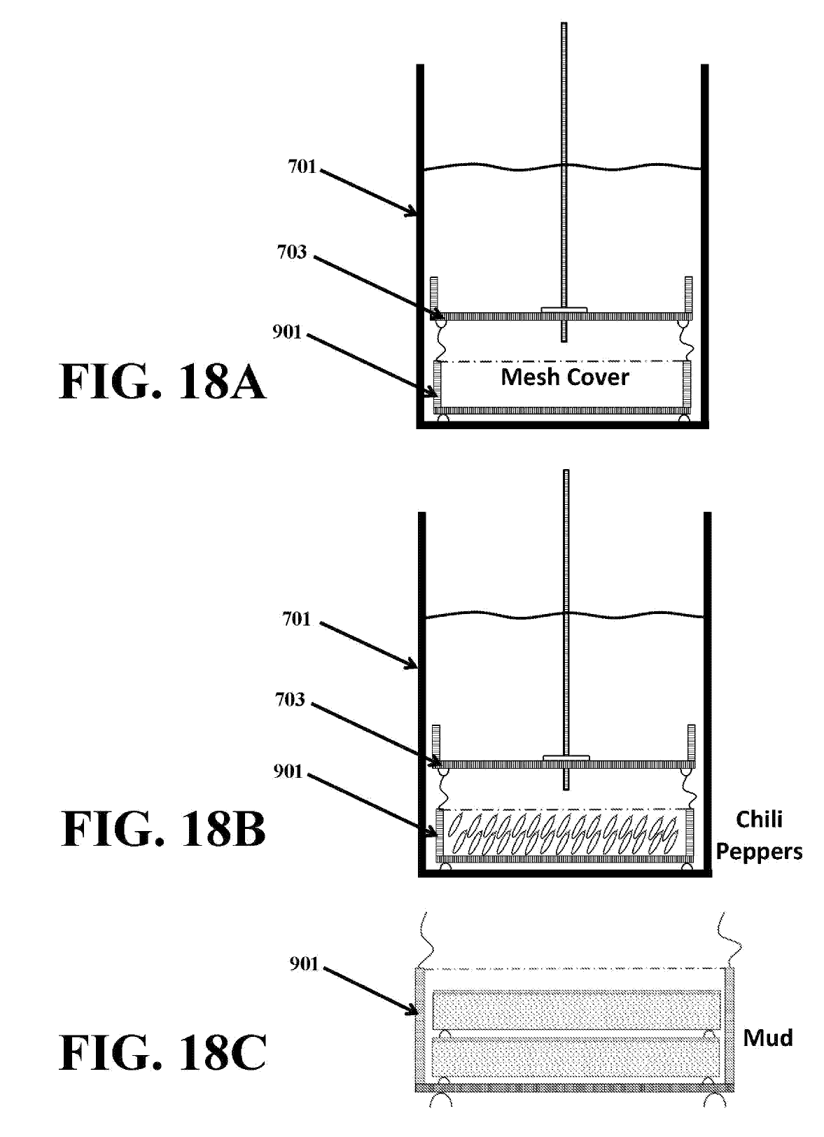

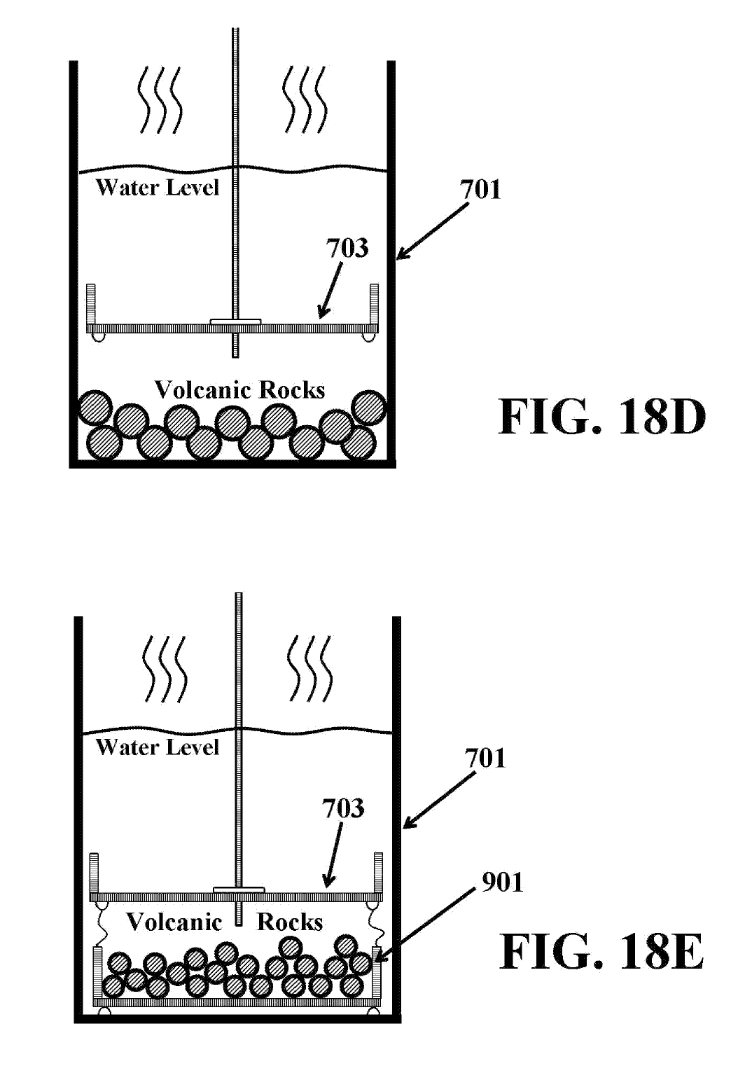

The present invention is a system to produce crystallized salt and bittern. The evaporator tank 701, which is a floating salt farm component 400, has at least one evaporator bin 901 inside evaporator tank 701, as shown in FIG. 18A, which is a holding device for placing contents, such that the contents affect selected properties of the crystallized salt and bittern, such as color, taste, smell, and mineral composition, during the evaporation of seawater.

At least one evaporator bin 901 inside the evaporator tank 701 is a holding device, such as a container, linked to the bottom of the evaporator plate 703. The sides of the evaporator bin 901 can have small holes in order to facilitate circulation of seawater through the contents inside the evaporator bin 901 during the evaporation of seawater. The top of the evaporator bin 901 can be encased with a mesh cover, which can be removed, in order to hold the contents inside. The mesh cover ensures that the contents stay inside the evaporator bin 901 during the evaporation of seawater. The contents to be held inside the evaporator bin 901, can be chili peppers, as shown in FIG. 18B, or mud, as shown in FIG. 18C. The contents inside the evaporator tank 701 can be placed below the evaporator plate 703, as shown in FIG. 18D. The contents can be volcanic rocks formed from the solidification of volcanic magma and found at a volcanic site or volcanic tuffs found at a volcanic site. The volcanic rocks can affect selected properties of the crystallized salt and bittern during the evaporation of seawater. The contents can also be held inside the evaporator bin 901 which is linked to the bottom of the evaporator plate 703 inside the evaporator tank 701. The contents can also be volcanic rocks inside the evaporator bin 901, as shown in FIG. 18E.

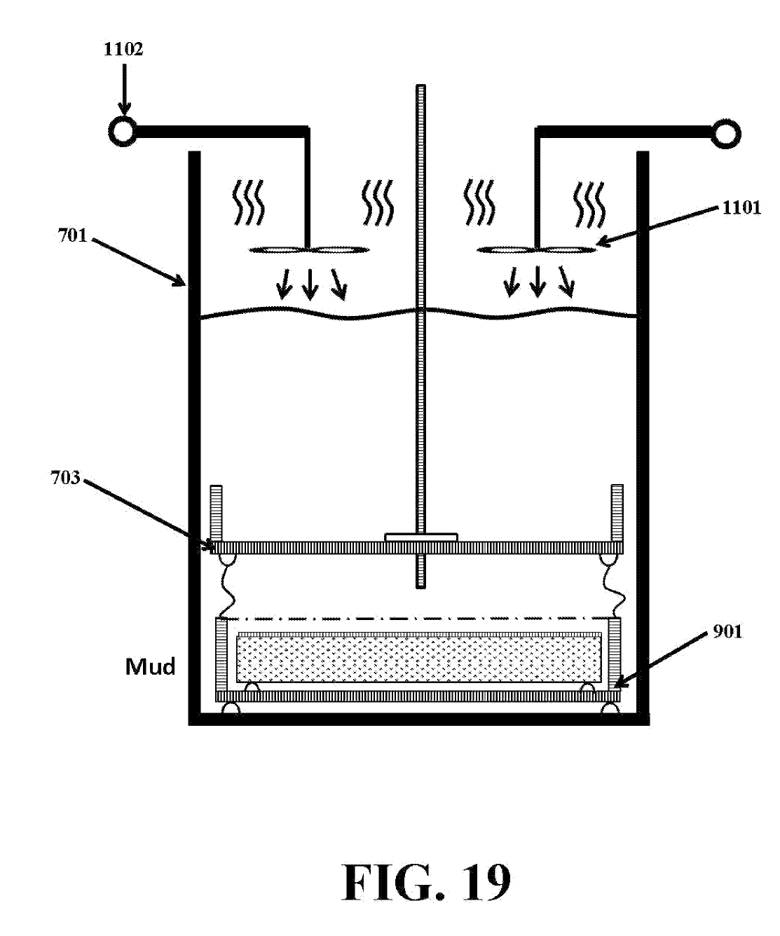

The present invention, the floating salt farm, is a system which can produce crystallized salt and bittern with similar properties to the properties of natural sun-dried salt and bittern produced in traditional salt ponds by placing mud inside the evaporator bin 901 inside the evaporator tank 701, as shown in FIG. 19. The mud placed inside the evaporator bin 901 can be mud used in traditional salt ponds to produce natural sun-dried salt and bittern. The evaporator tank 701 can have at least one wind propeller 1101 for emulating the sea breeze, which is installed inside the evaporator tank 701 and can be controlled with a wind propeller controller 1102, as shown in FIG. 19, and the heating time and the heating temperature can be adjusted during the evaporation of seawater accordingly, such that the produced crystallized salt and bittern have similar properties as natural sun-dried salt with selected mineral compositions.

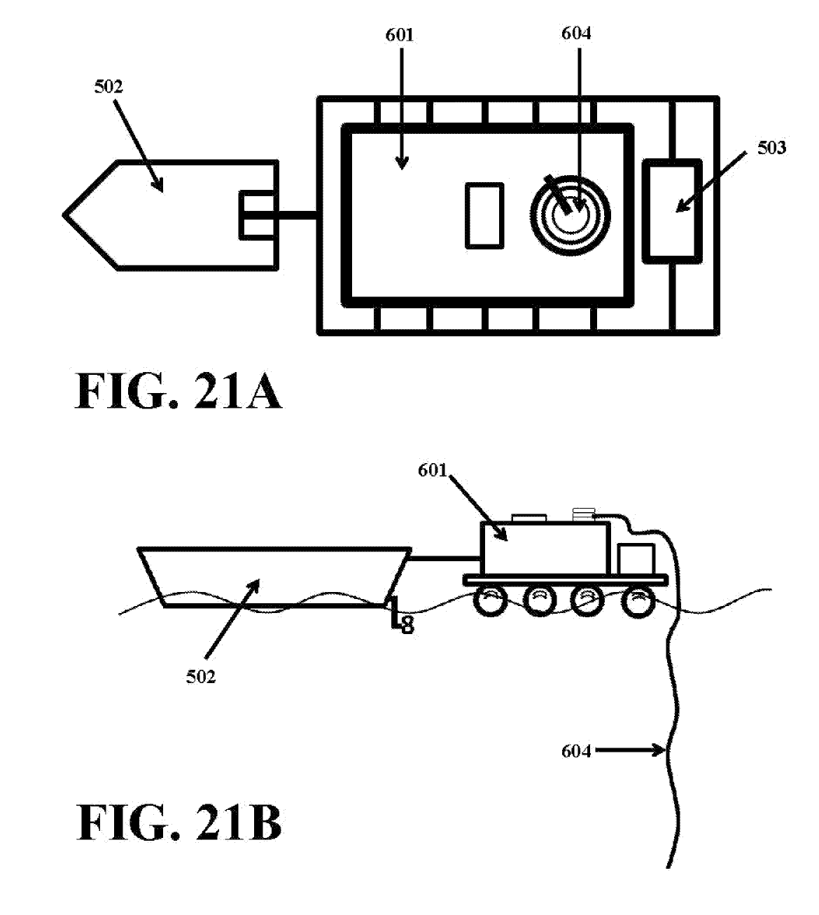

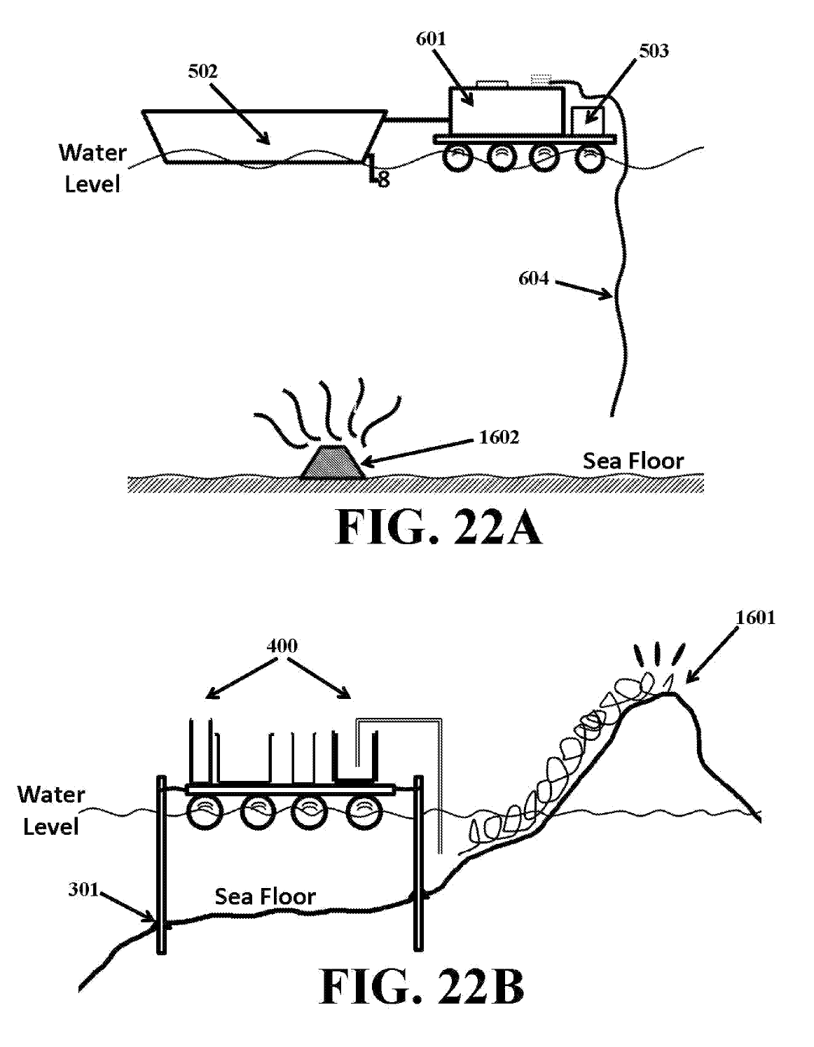

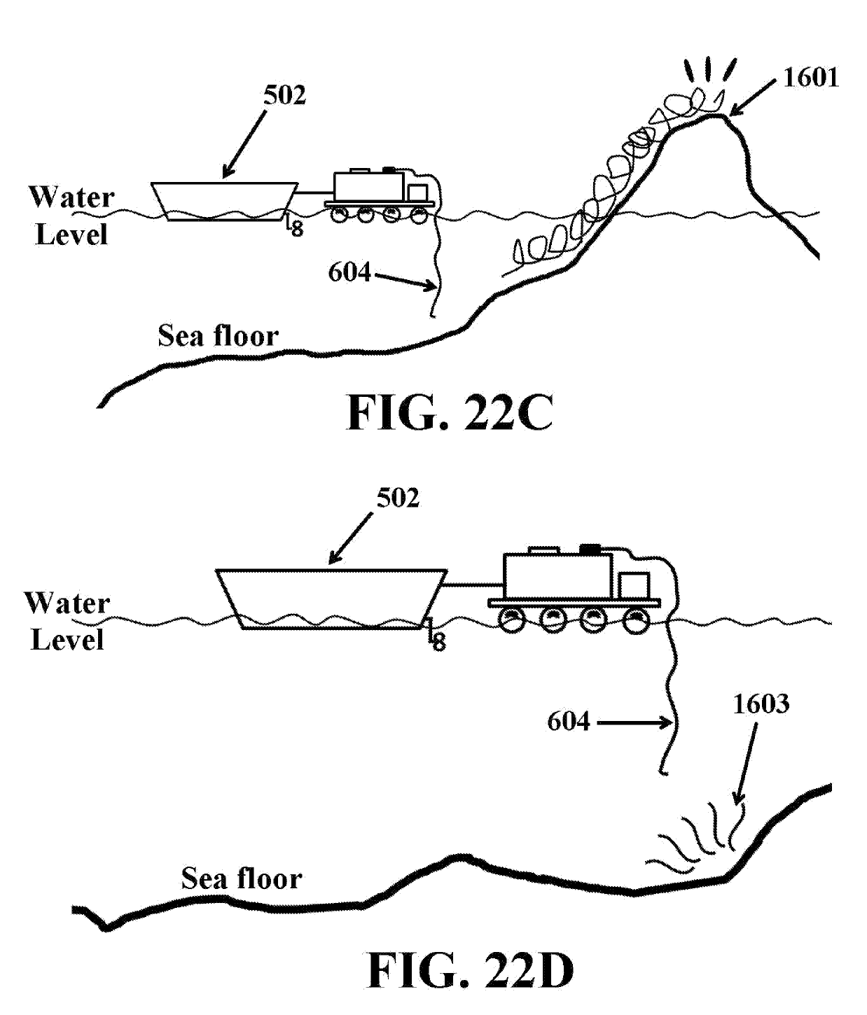

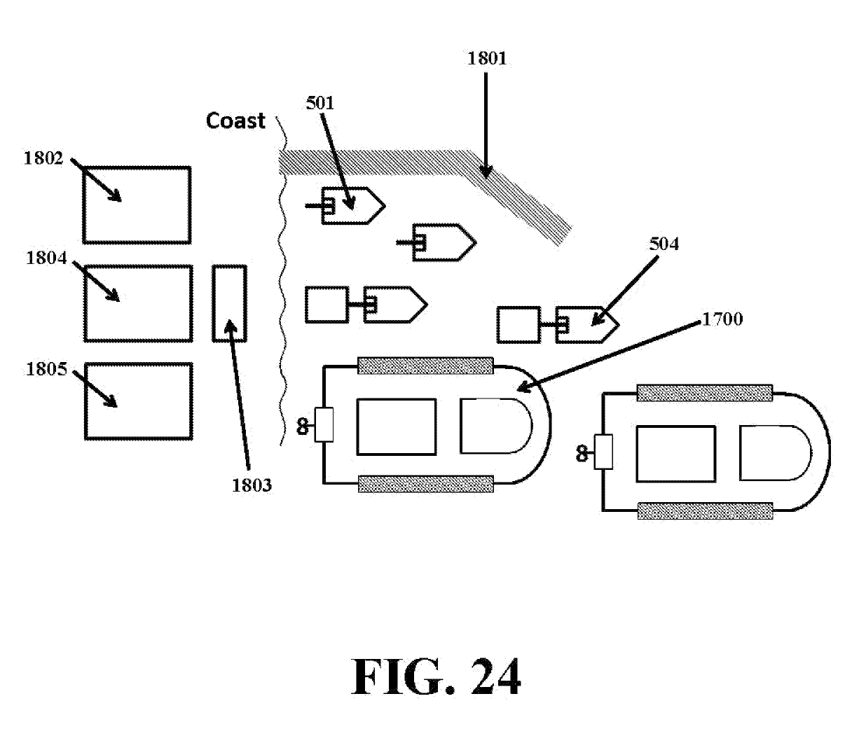

The crystallized salt from the deposit tank 1002 is placed into the storage tank 1004. The produced bittern from the evaporator tank 701 and the detached bittern from the deposit tank 1002 are pumped into the bittern storage tank 1007, which is a part of the storage tank 1004, as shown in FIG. 20. The storage tank 1004, which is a floating salt farm component 400, has a flooring at an angled slope to further help detach the bittern that is attached to the crystallized salt. At the bottom of the angled flooring can be a mesh opening 1003 to allow the detached bittern to seep through at the bottom of the slope, which leads to the bittern storage tank 1007. The storage tank 1004 can have windows, at least one wind propeller 1101 installed, and heaters 1005 to help dry the stored crystallized salt. The storage tank 1004 can also have temperature gauges 808 to assess the temperature inside the storage tank 1004 and a storage gate 1006 for transferring the crystallized salt from and to the storage tank 1004. The storage tank 1004 can also have a device to signal when the stored crystallized salt and stored bittern inside the storage tank 1004 and the bittern storage tank 1007, respectively, are ready to be transported to a warehouse 1802 on the harbor through at least one transport vessel 504, as shown in FIG. 24. The present invention, the floating salt farm, is a system that can be situated at selected offshore locations where seawater containing selected properties, such as mineral composition, can be extracted to produce crystallized salt and bittern containing selected properties. At least one seawater extraction vessel 502 connected to the seawater tank 601, as shown in FIG. 21A, is used for extracting seawater containing selected properties through the seawater extraction tube 604, which is powered by the seawater extraction pump 503. The extracted seawater is then transported to the floating salt farm to be used for evaporating the seawater to produce crystallized salt and bittern. The seawater to be extracted by at least one seawater extraction vessel 502 can be (1) seawater extracted at a selected water depth at an offshore location, as shown as FIG. 21B, (2) seawater extracted at an offshore location which is around a volcanic site with underwater volcanoes 1602, as shown in FIG. 22A, or volcanoes 1601 above sea level onshore, as shown in FIG. 22C, where the extracted seawater is affected by volcanic eruption activity, and (3) seawater extracted at an offshore location which is around an underwater thermal spring site 1603, as shown in FIG. 22D, where the extracted seawater is affected by underwater thermal erupted springs 1603. The floating salt farm components 400, which are fixed on the buoyant foundation 101, can extract seawater at an offshore location which is around a volcanic site with volcanoes 1601 above sea level onshore, as shown in FIG. 22B.

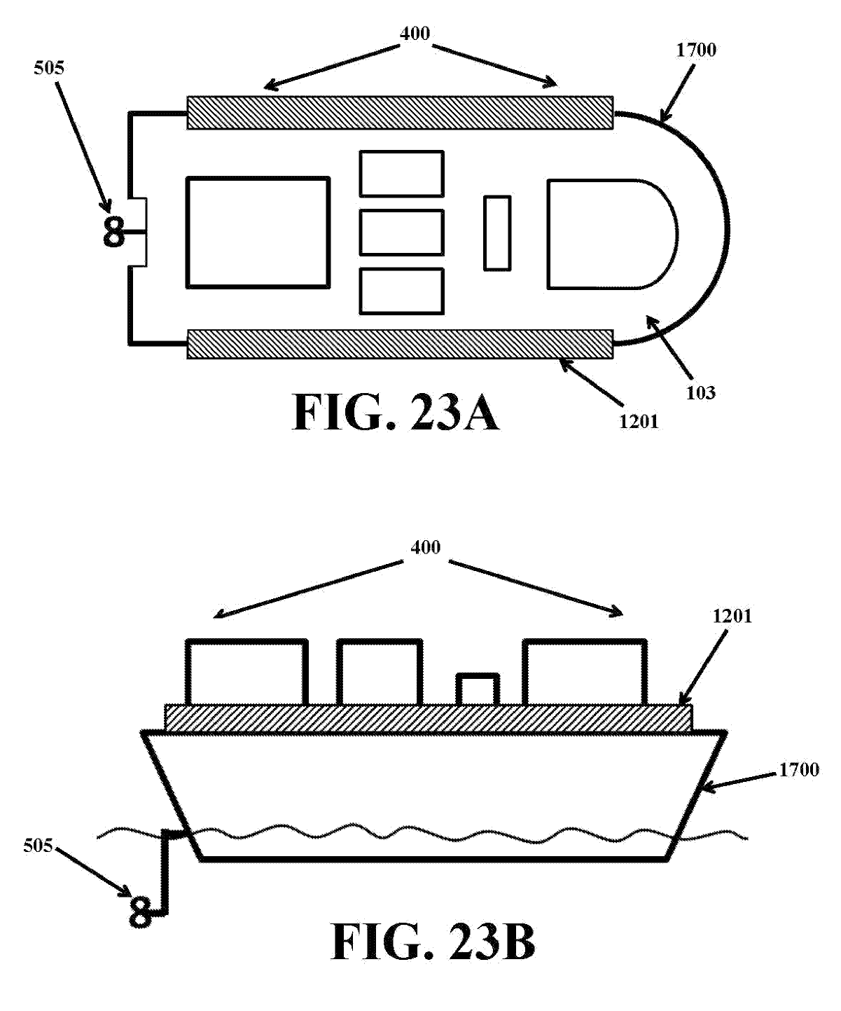

A barge 1700, a movable structure, can be used as a buoyant foundation 101, in which the floating salt farm components 400, which includes a plurality of photovoltaic panels 1201, are fixed on top of the flooring deck 103 of the barge 1700, and the barge 1700 can have a motor propeller 505 installed, as shown in FIGS. 23A and 23B.

The produced crystallized salt and bittern can be transported to a warehouse 1802 on the harbor, as shown in FIG. 24, through at least one transport vessel 504 from the floating salt farm situated at offshore locations. The crystallized salt and bittern can be further processed at other facilities on the harbor, such as the refinery and treatment plant 1804, and the packing facility 1805. The necessary materials and energy sources, which are used for the floating salt farm, can be transported from the energy source station 1803 on the harbor through at least one transport vessel 504. At least one towboat 501 and at least one barge 1700 can also be stationed at the harbor. The harbor can have harbor breakwaters 1801 for protecting stationed vessels. The harbor can be a safe location for the floating salt farm to be stationed during inclement weather conditions.

Drawing Reference Numerals

| | |
|---|---|
| 101 | Buoyant Foundation |
| 102 | Buoyant Support Structures |
| 103 | Flooring Deck |
| 104 | Tank Supports |
| 105 | Flat-bottomed Boats |
| 106 | Foundation Wall |
| 107 | Buoyant Sea Wall |
| 108 | Wind Opening |
| 109 | Customized Ceiling |
| 110 | Ceiling Window |
| 111 | Buoyant Structures |
| 200 | Breakwater |
| 301 | Offshore Structure |
| 302 | Support Structure |
| 400 | Floating Salt Farm Components |
| 501 | Towboat |
| 502 | Seawater Extraction Vessel |
| 503 | Seawater Extraction Pump |
| 504 | Transport Vessel |
| 505 | Motor Propeller |
| 601 | Seawater Tank |
| 602 | Filter System |
| 603 | Seawater Inlet |
| 604 | Seawater Extraction Tube |
| 701 | Evaporator Tank |
| 702 | Evaporator Tank Opening |
| 703 | Evaporator Plate |
| 704 | Circulation Opening |
| 705 | Evaporator Plate Surface |
| 707 | Evaporator Plate Support |
| 708 | Gearbox |
| 709 | Evaporator Plate Motor |
| 710 | Evaporator Plate Controller |
| 711 | Mixer |
| 714 | Evaporator Tank Cover |
| 801 | Heating Tank |
| 802 | Heat Exchanger |
| 803 | Heating Pipe |
| 804 | Pipe Coverings |
| 805 | Heating Tank Liquid |
| 806 | Heating Tank Opening |
| 807 | Liquid Inlet |
| 808 | Temperature Gauge |
| 809 | Gas Tank |
| 810 | Gas Burner |
| 811 | Heat Controller |
| 812 | Electric Heater |
| 813 | Energy Storage Tank |
| 901 | Evaporator Bin |
| 902 | Evaporator Bin Support |
| 903 | Mesh Cover |
| 1002 | Deposit Tank |
| 1003 | Mesh Opening |
| 1004 | Storage Tank |
| 1005 | Heater |
| 1006 | Storage Gate |
| 1007 | Bittern Storage Tank |
| 1101 | Wind Propeller |
| 1102 | Wind Propeller Controller |
| 1201 | Photovoltaic Panels |
| 1202 | Electric Cable |
| 1203 | Wind Turbine |
| 1300 | Pressurized Hose |
| 1402 | Crystallized Salt Extraction Tube |
| 1502 | Bittern Extraction Tube |
| 1601 | Volcano |
| 1602 | Underwater Volcano |
| 1603 | Underwater Thermal Springs |
| 1700 | Barge |
| 1801 | Harbor Breakwater |
| 1802 | Warehouse |
| 1803 | Energy Source Station |
| 1804 | Refinery and Treatment Plant |
| 1805 | Packing Facility |

What is claimed is:

1. A system situated at an offshore location for producing crystallized salt and bittern, the system comprising:
a buoyant foundation being situated on the surface of a body of seawater, the buoyant foundation comprising:
at least one offshore structure or support structure installed onshore, connected to the buoyant foundation, for reinforcement; and
a motor propeller installed or a towboat connected to the buoyant foundation, for movement; and
components being fixed on the buoyant foundation, the components consisting essentially of:
a seawater tank for extracting the seawater at the offshore location;
an evaporator tank for evaporating the seawater which is pumped from the seawater tank to produce the crystallized salt and the bittern, the evaporator tank comprising:
an evaporator plate for capturing the crystallized salt which is produced and the surface of the evaporator plate being a sieve surface;
an evaporator tank opening for releasing water vapor which is produced, to the atmosphere; and
at least one wind propeller for supplying breeze; and
a heating tank for supplying heating energy to the evaporator tank;
a deposit tank for detaching the bittern attached to the crystallized salt which is pumped from the evaporator tank, the deposit tank comprising a flooring with an angled slope;
a storage tank for drying and storing the crystallized salt which is pumped from the deposit tank and storing the bittern which is pumped from the evaporator tank and the deposit tank, the storage tank comprising a flooring with an angled slope, a heater and at least one wind propeller, and
a plurality of photovoltaic panels for supplying electricity to the heating tank.

2. The system according to claim 1, wherein said evaporator tank further comprises at least one evaporator bin, said at least one evaporator bin being a holding device for placing contents and being inside said evaporator tank, such that the contents affect properties of said crystallized salt and said bittern.

3. The system according to claim 1, further comprising a seawater extraction vessel connected to the seawater tank for extracting seawater at the offshore location, the seawater extraction vessel being situated at (a) the offshore location where the seawater is extracted at a selected water depth or (b) the offshore location being around a volcanic site where the seawater is affected by volcanic eruption activity, and
wherein the seawater has selected mineral compositions.

4. The system according to claim 2, wherein said contents are mud which can be used in salt ponds, such that said crystallized salt and said bittern have properties of natural sun-dried salt and bittern which are produced in salt ponds.

5. The system according to claim 1, wherein said buoyant foundation is a movable structure comprising a barge with a motor propeller.

6. The system according to claim 1, wherein said components further consist of at least one energy storage tank, said at least one energy storage tank being a storing component for accumulating electricity generated from (a) said plurality of photovoltaic panels, (b) at least one offshore wind turbine, or (c) a combination of said plurality of photovoltaic panels and said at least one offshore wind turbine; and
wherein said at least one energy storage tank supplies said electricity for operating said components.

7. The system according to claim 1, wherein said heating tank comprises a heat controller, said heat controller being a device for adjusting heating time and heating temperature for evaporating said seawater, such that said crystallized salt and said bittern have selected properties.

8. The system according to claim 1, wherein at least one of said components is fixed on at least one said buoyant foundation.

9. The system according to claim 1, wherein said at least one offshore structure is combined with said at least one support structure installed onshore, such that said at least one offshore structure combined with said at least one support structure installed onshore can reinforce said buoyant foundation.

10. The system according to claim 1, wherein said buoyant foundation further comprises a buoyant sea wall connected with detachable connections, said buoyant sea wall being a floating structure for increasing buoyancy of said buoyant foundation.

11. The system according to claim 1, wherein said deposit tank and said storage tank are installed at (a) said offshore location or (b) said onshore location; and
wherein said deposit tank and said storage tank can be installed at a harbor.

12. The system according to claim 1, wherein said heating tank supplies said heating energy, said heating energy being generated by using a combination of energy sources.

13. The system according to claim 3, wherein at least one said seawater extraction vessel comprises a seawater extraction tube for extracting the seawater at the offshore location, said at least one seawater extraction vessel being situated at (a) the offshore location being around the volcanic site with underwater volcanoes or volcanoes above sea level onshore, where the seawater is affected by said volcanic eruption activity, or (b) the offshore location being around an underwater thermal spring site where the seawater is affected by underwater thermal erupted springs; and
wherein the seawater has selected mineral compositions.

14. The system according to claim 2, wherein said contents are volcanic rocks, said volcanic rocks being found at a volcanic site, such that said volcanic rocks affect said properties of said crystallized salt and said bittern.

15. The system according to claim 5, wherein at least one said barge comprises a plurality of photovoltaic panels, said plurality of photovoltaic panels being components for generating electricity; and
wherein said at least one barge moves to an offshore location for intaking sunlight with said plurality of photovoltaic panels.
